(19) United States
(12) Patent Application Publication
(10) Pub. No.: US 2024/0131450 A1
(43) Pub. Date: Apr. 25, 2024

(54) CHARGED DEPTH FILTER FOR THERAPEUTIC BIOTECHNOLOGY MANUFACTURING PROCESS

(71) Applicant: 3M INNOVATIVE PROPERTIES COMPANY, St. Paul, MN (US)

(72) Inventors: Kuan-Yin LIN, Woodbury, MN (US); Andrew W. VAIL, Bayport, MN (US); Daniel J. O'NEAL, St. Paul, MN (US); Masayuki NAKAMURA, Woodbury, MN (US); Jonathan F. HESTER, Hudson, WI (US); Kannan DASHARATHI, St. Paul, MN (US); Alexei M. VOLOSHIN, Woodbury, MN (US)

(21) Appl. No.: 18/547,792

(22) PCT Filed: Feb. 24, 2022
(86) PCT No.: PCT/IB2022/051648

§ 371 Date: Aug. 24, 2023

Related U.S. Application Data
(60) Provisional application No. 63/154,299, filed on Feb. 26, 2021.

(51) Int. Cl. B01D 15/34; B01D 15/22; B01D 15/36

(52) U.S. Cl. CPC B01D 15/34; B01D 15/22; B01D 15/36

(57) ABSTRACT

A charged depth filter for removing cells and/or cellular debris from a biopharma feedstock having a first functionalized nonwoven layer having a first calculated pore size and a first dynamic charge capacity; a second functionalized nonwoven layer having a second calculated pore size and a second dynamic charge capacity positioned after the first functionalized nonwoven layer in the direction of the biopharma feedstock flow, and wherein the first calculated pore size is greater than the second calculated pore size, and the first dynamic charge capacity is less than the second dynamic charge capacity.

### BACKGROUND

Monoclonal antibodies are a major modality in the biopharmaceutical industry based on their specificity to target diseases. The therapeutic antibody market has been growing at a rapid pace with many drug candidates under regulatory review. Approximately 100 monoclonal antibodies have been approved by the U.S. and European Union regulatory agencies over the last 30 years and next generation antibody therapies are expected at an even higher rate over the next 10 years. These include antibody-drug conjugates, biosimilars, engineered antibodies, bispecific antibodies, antibody fragments, antibody-like proteins, and more. Chinese hamster ovary (CHO) cells are the most commonly used cell line in the industry based on their ability to adapt and grow in suspension, grow in serum-free chemically defined medium, high production capabilities, posttranslational modifications, and more. CHO cells account for >70% of produced protein therapeutics but these biologics can be produced in several systems including microbes, plants, insects, other mammalian cells.

Proteins of biopharmaceutical interest include any of a multitude of natively or recombinantly expressed proteins. Other biologics that may be used as therapeutic vectors include viral particles such as adenoviruses, adeno-associated viruses (AAVs), or lentiviruses; bacterial phages or viral particles; exozomes; or synthetic lipid nanoparticles. Aside from CHO cells, host cells that may be used to produce these biologics include other mammalian cell types such as human embryonic kidney (HEK) cells, HeLa cells, or PER.C6 cells; bacteria such as Escherichia coli or bacillus; insect cells such as Sf6; yeast cells; or plant cells such as tobacco. Regardless of the cell type or therapeutic vector, the clarification and purification challenges related to isolating the biologic of interest from the host cell components, and from other components produced by the host cells, can share similarities.

### SUMMARY

In the biopharmaceutical manufacturing, there is a need to separate the target biomolecule of interest, such as a monoclonal antibody (mAb), virus particle or other therapeutic vector, from a feedstock comprising cells, cellular debris, and/or colloidal particulates once the cell culture fluid is harvested from the bioreactor and sent to the downstream clarification processes. Often the primary clarification step is done using a centrifuge step, depth filtration, microfiltration (tangential flow filtration), or combinations thereof to remove the whole cells and large cellular debris from harvested cell culture fluid.

Significant advances in cell media, cell engineering, and bioreactor design have led to higher titers (e.g., 10 g/L) over the years. The resulting cultures also have increased cell densities from 6 million cells/mL up to more than 50 million cell/mL. This significant increase in cell density has impacted numerous primary clarification steps.

Centrifuges when used for primary clarification require extensive cleaning procedures between runs to ensure there is no cross contamination between successive batches in the production process. Hence, there is a need for disposable, single use devices to replace the primary centrifuge clarification step to eliminate the risk of cross-contamination when changing between batches and therapeutic biomolecules of interest.

Tangential flow microfiltration can be used as the primary clarification step in place of the centrifuge. However tangential flow microfiltration membranes are often susceptible to membrane fowling and they too require an extensive cleaning procedure to prevent cross contamination between runs and when changing between therapeutic biomolecules of interest.

Alternatively, a conventional depth filter (using size exclusion only based on media pore size) can be used as the primary clarification step to remove cells and debris based on size of depth filter channels and filter aides in the depth filter media. However, as cell density increases from 6 million cells/mL to more than 50 million cell/mL, throughput by conventional depth filtration has become unworkable in a production manufacturing environment. Therefore, what is needed is a single use primary clarification step that can replace centrifuges, tangential flow microfiltration, and conventional depth filters as the primary clarification step.

Applicants have found that a charged depth filter having at least two functionalized nonwoven layers with each layer having a different effective pore size and dynamic charge capacity can accomplish such a task and is especially effective with cell cultures having a high cell density. By carefully managing the gradient for both the effective pore size and the dynamic charge capacity as the feedstock moves through the depth filter's layers, a depth filter can be constructed that does not cake over and plug the first layer with whole cells and large cellular debris and is still effective to ensure the last layer of the depth filter, such as a membrane layer, also does not plug with debris. Both situations result in significantly reduced throughput making the device unacceptable for use in a production biopharma manufacturing process.

In particular, the Applicants have found that the pore size for successive layers in the charged depth filter should decrease and the dynamic charge capacity for successive layers in the charged depth filter should increase. If the pore size is too small, or the dynamic charge capacity is too great for the first layer of the functionalized nonwoven that the feedstock sees in the depth filter, it will readily cake with whole cells and/or large cellular debris significantly reducing throughput. Similarly, by failing to reduce the pore size and increase the dynamic charge capacity of successive layers, too many debris will slip through the functionalized nonwoven layers leading to plugging of downstream filtration members that can be optionally added as a final filter layer to the charged depth filter.

Hence in one aspect the invention resides in a charged depth filter for removing cells and/or cellular debris from a biopharma feedstock having a first functionalized nonwoven layer having a first calculated pore size and a first dynamic charge capacity; a second functionalized nonwoven layer having a second calculated pore size and a second dynamic charge capacity positioned after the first functionalized nonwoven layer in the direction of the biopharma feedstock flow, and wherein the first calculated pore size is greater than the second calculated pore size, and the first dynamic charge capacity is less than the second dynamic charge capacity.

### BRIEF DESCRIPTION OF THE DRAWINGS

FIG. 1 is a schematic of a media stack for a charged depth filter having four layers of a functionalized nonwoven (FNW-C/FNW-C/FNW-E/FNW-F), followed by a membrane layer, and followed by a nonwoven spunbond layer positioned between the inlet and the outlet of the charged depth filter.

FIG. 2 is an image of a functionalized nonwoven layer, FNW-B. The nonwoven prior to functionalization had an effective fiber diameter of 14 μm, solidity of 10%, basis weight of 200 g/m², and calculated pore size of 41.5 μm. After grafting, it has an effective fiber diameter of 21.6 μm, solidity of 14.2%, basis weight of 302.0 g/m², calculated pore size of 50.5 μm, and MY DCC of 165.0 mg/g.

FIG. 3 is an image of a functionalized nonwoven layer, FNW-F. The nonwoven prior to functionalization had an effective fiber diameter of 6 μm, solidity of 10%, basis weight of 200 g/m², and calculated pore size of 17.8 μm. After grafting, it had an effective fiber diameter of 9.1 μm, solidity of 17.8%, basis weight of 355.8 g/m², calculated pore size of 17.9 μm, and MY DCC of 407.4 mg/g.

FIG. 4 is an image of a dissected charged depth filter media stack of a larger pore functionalized nonwoven, FNW-B, and membrane after cell culture clarification. The cell culture easily penetrates through all four functionalized nonwoven layers and covers the membrane surface with remnants of cells and cell debris. This media stack did not perform well since too much debris fouled the membrane layer.

FIG. 5 is an image of a dissected charged depth filter media stack of a smaller pore functionalized nonwoven, FNW-F, and membrane after cell culture clarification. The cell culture fouls the upper layers and cannot penetrate through all the functionalized nonwoven layers. The third and fourth layers are not utilized, and the membrane surface is clean without any remnants of cell and cell debris.

FIGS. 6A and 6B show the top surface of the first functionalized nonwoven (FNW-C) in the media stack after filtering a CHO cell culture. Cells, debris, and/or DNA stick to the charged fibers of the nonwoven layer and look like round balls on the outer surfaces of the functionalized fibers.

FIG. 6C shows the bottom surface of the first functionalized nonwoven (FNW-C) in the media stack after filtering the CHO cell culture. Cells, debris, and/or DNA stick to the charged fibers of the nonwoven layer and look like round balls on the outer surfaces of the fibers.

FIG. 6D shows the top surface of the second functionalized nonwoven (FNW-C) in the media stack after filtering the CHO cell culture. Cells, debris, and/or DNA stick to the charged fibers of the nonwoven layer and look like round balls on the outer surfaces of the fibers.

FIG. 6E shows the bottom surface of the second functionalized nonwoven (FNW-C) in the media stack after filtering the CHO cell culture. Cells, debris, and/or DNA stick to the charged fibers of the nonwoven layer and look like round balls on the outer surfaces of the fibers.

FIG. 6F shows the top surface of the functionalized nonwoven (FNW-E) in the media stack after filtering the CHO cell culture. Cells, debris, and/or DNA stick to the charged fibers of the nonwoven layer and look like round balls on the outer surfaces of the fibers.

FIG. 6G shows the bottom surface of the functionalized nonwoven (FNW-E) in the media stack after filtering the CHO cell culture. Cells, debris, and/or DNA stick to the charged fibers of the nonwoven layer and look like round balls on the outer surfaces of the fibers.

FIG. 6H shows the top surface of the functionalized nonwoven (FNW-F) in the media stack after filtering the CHO cell culture. Cells, debris, and/or DNA stick to the charged fibers of the nonwoven layer and look like round balls on the outer surfaces of the fibers.

FIG. 6I shows the bottom surface of the functionalized nonwoven (FNW-F) in the media stack after filtering the CHO cell culture. Cells, debris, and/or DNA stick to the charged fibers of the nonwoven layer and look like round balls on the outer surfaces of the fibers.

FIG. 6J shows the top surface of the 0.2 μm membrane layer in the media stack after filtering the CHO cell culture. As seen very little cells, debris, and/or DNA are present on the surface of the membrane.

FIG. 7 shows a perspective view of a charged depth filter having a housing with an inlet, an outlet, an optional vent, and a media stack (not shown) positioned between the inlet and the outlet to clarify a cell culture.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting and information that is relevant to a section heading may occur within or outside of that particular section.

The term “about” as used herein can allow for a degree of variability in a value or range. For example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less.

As used herein “layer” means a thickness of material the fluid to be processed passes through wherein the material in the layer is all formed from the same material. A layer can be a monolithic layer formed from a thickness of the same material. Or a layer can have one or more discrete plies of the same material stacked one on top of another within the layer to form its thickness. For example, a layer of common facial tissue is often a tissue paper material that is made from two individual plies of tissue paper placed in face to face contact and the two individual plies can be easily separated from each other as they are commonly held together by weak mechanical bonds in the form of crimp lines.

As used herein “a ply or plies” is a single thickness of material that can be processed by conventional converting operations such as, but not limited to, winding, folding, cutting, or stacking into a layer. Often a ply is a thickness of material after it completes the formation process on a web manufacturing machine. Thereafter, one or more plies of the same material may be stacked to form a layer. For example, a nonwoven can be made as a single ply on a formation machine and wound into a roll. Thereafter, the nonwoven roll may be unwound and folded in half in the cross-machine direction by a folding board as it passes longitudinally through a converting machine and then the two-ply layer cut into discs by a cutting die to form a circular layer of the nonwoven material having two discrete plies.

As used herein a “functionalized layer” is a layer that will attract target particles or molecules by attractive forces such as electrostatic forces due to the presence at the surfaces of that layer of one or more of chemical moieties, ligands, or functional groups that are distinct from the materials forming the bulk of the layer which are providing primarily its structural shape and integrity. The chemical moieties, ligands, or functional groups are specifically intended to attract the target particles or molecules to the surfaces of the functionalized layer. Functionalized layers may be created by coating or grafting a porous layer with ligands, monomers, or polymers designed to molecularly attract the target particles or molecules. Alternatively, functionalized layers may be created by the provision, in the formulation used to make such layers, of surface modifying polymers or chemical moieties that become localized at the surfaces of the layer during its formation, resulting in the presence on the surfaces of the layer of chemical groups designed to attract the target particles or molecules. In some embodiments, the attractive force between the functional groups on the surfaces of the functionalized layer are electrostatic forces, and the chemical moieties, ligands, or polymers present on the surfaces of the functionalized layer are electrostatically charged. A functionalized layer may have a positive charge and attract negatively charged particles, i.e., anion exchange chromatography, or the functionalized layer may have a negative charge and attract positively charged particles, i.e., cation exchange chromatography. In other embodiments, the attractive forces may be Van der Waals forces, and the target particles or molecules are attracted to the functional groups on the functionalized layer surfaces by mutual relative concentration or paucity of polarizable or hydrogen bonding moieties (i.e., hydrophobic interaction). Further, the attractive forces may include a combination of electrostatic and Van der Waals forces (i.e., mixed mode). Functionalized material suitable for the functionalized layers in the charged depth filter device are made by Pall, Millipore, and Sartorious and sold under the following brands: Mustang® Q, NatriFlo® HD-Q and Sartobind® Q. Functionalized layers suitable for use in the charged depth filter device can be nonwovens, membranes, or other suitable materials. A preferred functionalized nonwoven material is made by 3M Company and disclosed in U.S. Pat. No. 9,821,276 entitled “Nonwoven Article Grafted with Copolymer.” A preferred functionalized membrane is made 3M Company and disclosed in U.S. Pat. Nos. 9,650,470; and 10,017,461 entitled “Method of Making Ligand Functionalized Substrates.” All three mentioned patents are herein incorporated by reference in their entirety.

As used herein a “non-functionalized layer” is a layer without coated, grafted, or surface-localized attractive chemical moieties (e.g., electrostatically charged chemical moieties, ligands, or functional groups) distinct from the materials forming the bulk of the layer.

As used herein a “media stack” is all the material layers the fluid to be processed passes through within the charged depth filter's housing as the fluid moves from the inlet, through the housing, to the outlet.

As used herein, a “membrane” refers to a synthetic liquid permeable membrane comprising a sheet of material in which are disposed a plurality or an interconnected network of pores enabling passage of fluid through the membrane. Such membranes include polymeric membranes which are commonly made by phase inversion processes wherein a homogeneous solution of one or more polymers in a suitable solvent or combination of solvents is caused to undergo phase separation to form a porous structure. Phase separation can be brought about by introducing a film of the homogeneous solution to a nonsolvent bath (known as diffusion induced phase separation) or to a nonsolvent atmosphere (known as vapor induced phase separation) or by changing the temperature of the homogeneous solution (known as thermally induced phase separation). Alternatively, pores can be formed in polymeric sheets by stretching processes or by irradiation processes (track etch membranes). Membranes can have pore sizes of about 0.1 to about 20 micrometers in diameter (microporous membranes) or pore sizes less than about 0.1 micrometers (ultraporous membranes). Suitable polymers for forming membranes include cellulose acetate, nitrocellulose, cellulose esters, polysulfones including Bisphenol A polysulfone and polyethersulfone, polyacrylonitrile, polyamides (e.g., Nylon-6 and Nylon-6,6), polyimides, polyethylene, polypropylene, polytetrafluoroethylene, polyvinylidene fluoride, polyvinylchloride, and ethylene-chlorotrifluoroethylene copolymers.

### Charged Depth Filter

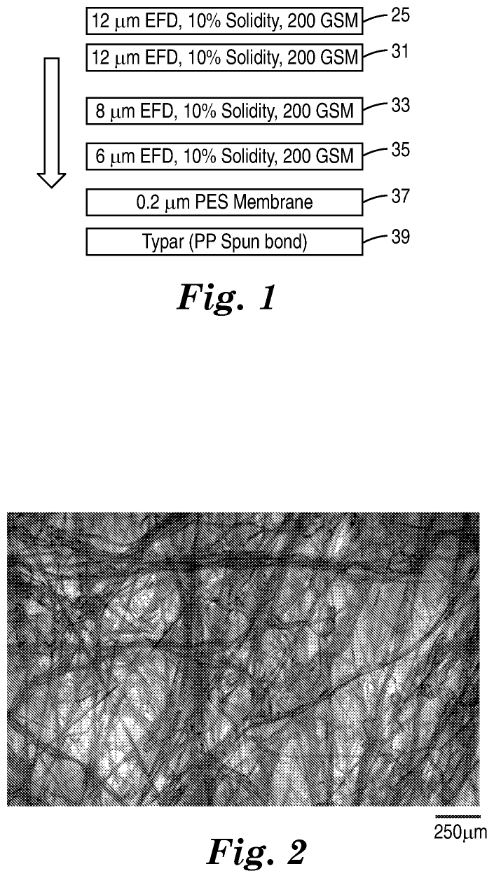

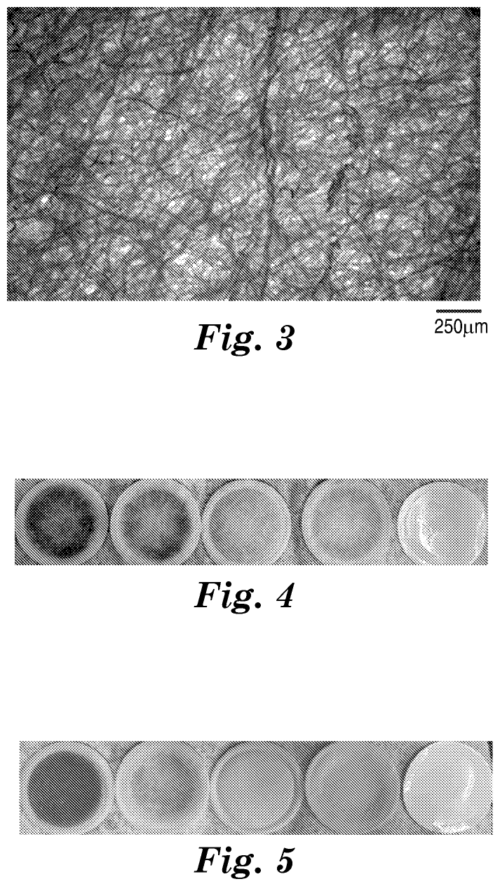

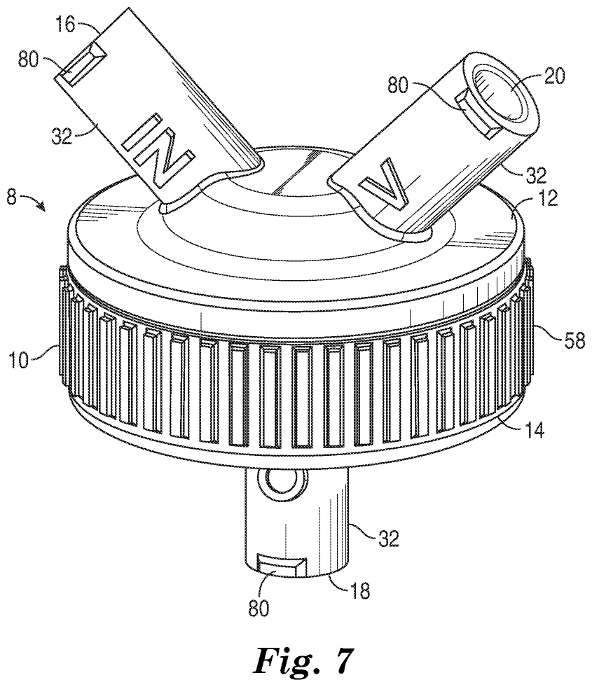

Referring to FIGS. 1 and 7, the charged depth filter comprises a housing 10 having an inlet 16, an outlet 18, an optional vent 20, and a media stack comprising layers 25, 31, 33, 35, 37, and 39 (FIG. 1) located within the housing comprising at least two layers of a functionalized nonwoven disposed between the inlet and the outlet such that the cell culture to be filtered passes through the media stack from the inlet 16 to the outlet 18. The edges of the media stack are sealed, for example, by a compression or thermoplastic welded seal to minimize or eliminate any leakage of the cell culture to the outlet without first passing through the media stack. Any suitable housing can be used for the charged depth filter that can contain and seal the media stack. Often different size housings and media stack volumes are provided that are suitability for laboratory bench scale studies to commercial production.

The media stack has at least a first functionalized nonwoven layer 25 having a first calculated pore size and a first dynamic charge capacity; and a second functionalized nonwoven layer 33 having a second calculated pore size and a second dynamic charge capacity positioned after the first functionalized nonwoven layer in the direction of the biopharma feedstock flow; and wherein the first calculated pore size is greater than the second calculated pore size, and the first dynamic charge capacity is less than the second dynamic charge capacity.

The housing can be any suitable size, with the size scaled as appropriate to the media surface area within the housing. Typically, laboratory scale devices will be relatively small and have low hold-up volumes for processing limited amounts of fluid. Pilot scale and production scale devices will have corresponding larger amounts of media within them to process larger amounts of fluid for each run. For example, laboratory scale devices may have media surfaces areas from 3.2 cm² to 25 cm², pilot scale devices from 340 cm² to 1020 cm², and production scale devices from 2300 cm² to 16,100 cm². Other housing sizes and media volumes can be provided as needed for the specific application. Suitable housings are made by 3M and used in the 3M Emphaze AEX Hybrid Purifier product line. See https://www.3m.com/3M/en_US/company-us/all-3m-products/˜/3M-Emphaze-AEX-Hybrid-Purifier/?N=5002385+3291555558&rt=rud. Similar size housings and designs can be used to contain the media stack of this invention.

A suitable housing is disclosed in U.S. patent application Ser. No. 62/792,166 filed on Jan. 14, 2019, entitled Sample Size Chromatography Device, and herein incorporated by reference in its entirety. As best seen in FIG. 7, the housing 10 is formed by joining an upper housing 12 to a lower housing 14. The housing has an inlet 16, an outlet 18, and an optional vent 20. Disposed between the inlet 16 and the outlet 18 is a media stack in a chamber such that fluid from the inlet 16 enters the internal chamber and then passes through the media stack and out the outlet 18. The chamber is in fluid communication with the inlet 16 and the optional vent 20 such that any air in the chamber can be purged out the vent 20. A Luer lock connector (not shown) can be attached to the vent 20 and used as a valve to purge the air from the chamber until liquid from the inlet 16 begins to exit from the vent 20 and the valve is closed. Cylindrical projections 32 with opposing transverse tabs 80 extend from the housing and have a tapered bore to attach the Luer Lock connectors to the inlet, the outlet, and the vent. Longitudinal ribs 58 are spaced along the perimeter to provide enhanced grip while handling the housing.

Another suitable housing having a sealing membrane and a spacer ring is disclosed in U.S. patent application Ser. No. 63/023,488 entitled Membrane Sealing Layer and Spacer Ring for Viral Clearance Chromatography Device filed May 12, 2020, and herein incorporated by reference in its entirety.

### Media Stack

The media stack comprises a first functionalized nonwoven layer 25 and a second functionalized nonwoven layer 33 disposed between the inlet and the outlet of the housing. The first functionalized nonwoven layer has a first calculated pore size and a first dynamic charge capacity; and the second functionalized nonwoven layer has a second calculated pore size and a second dynamic charge capacity and is positioned after the first functionalized nonwoven layer in the direction of the biopharma feedstock flow, and wherein the first calculated pore size is greater than the second calculated pore size, and the first dynamic charge capacity is less than the second dynamic charge capacity.

As used herein the “first” layer and the “second” layer does not mean these layers must literally be the first and the second layer the fluid passes through as it moves through the media stack. Rather they indicate relative positions to each other in that the fluid will flow through the first layer first and then through the second layer and there could be proceeding layers and/or intermediate layers in the media stack too. For example, the media stack could comprise in the direction of fluid flow layer A, then the first layer, layer B, layer C, then the second layer, and layer D. Likewise, other identified numerical layers, such as the third functionalized nonwoven layer, are treated the same way.

Better performance for a charged depth filter using two functionalized nonwoven layers was observed from the Examples when the first functionalized nonwoven 25 layer had a first calculated pore size from 40.8 μm to 65.0 μm and a first dynamic charge capacity from 150 MY DCC mg/g to 300 MY DCC mg/g when combined with a second functionalized nonwoven layer 33 having a second calculated pore size from 5.0 μm to less than 40.8 μm and a second dynamic charge capacity from greater than 300 MY DCC mg/g to 650 MY DCC mg/g. Alternatively, better performance for the two layer charged depth filter can result when the first functionalized nonwoven layer 25 had a first calculated pore size from 55.0 μm to 65.0 μm and a first dynamic charge capacity from 150 MY DCC mg/g to 300 MY DCC mg/g when combined with a second functionalized nonwoven layer 233 having a second calculated pore size from 5.0 μm to less than 55.0 μm and a second dynamic charge capacity from greater than 300 MY DCC mg/g to 650 MY DCC mg/g.

Better performance for a charged depth filter using three functionalized nonwoven layers was observed from the Examples when the first functionalized nonwoven 25 layer had a first calculated pore size from 40.8 μm to 65.0 μm and a first dynamic charge capacity from 150 MY DCC mg/g to 300 MY DCC mg/g, followed by a second functionalized nonwoven layer 33 having a second calculated pore size from 20.6 μm to less than 40.8 μm and a second dynamic charge capacity from greater than 300 MY DCC mg/g to 475 MY DCC mg/g, followed by a third functionalized nonwoven layer 35 having a third calculated pore size from 5.0 μm to less than 20.6 μm and a third dynamic charge capacity from greater than 300 MY DCC mg/g to MY DCC 650 mg/g. Alternatively, better performance for the three layer charged depth filter can result when the first functionalized nonwoven layer 25 had a first calculated pore size from 55.0 μm to 65.0 μm and a first dynamic charge capacity from 150 MY DCC mg/g to 300 MY DCC mg/g when combined with a second functionalized nonwoven layer 33 having a second calculated pore size from 20.6 μm to less than 55.0 μm and a second dynamic charge capacity from 200 MY DCC mg/g to 475 MY DCC mg/g, followed by a third functionalized nonwoven layer 35 having a third calculated pore size from 5.0 μm to less than 20.6 μm and a third dynamic charge capacity from greater than 300 MY DCC mg/g to 650 MY DCC mg/g.

When using three layers of a functionalized nonwoven, better performance was observed when the third functionalized nonwoven layer is water permeable. If the pore size becomes to small due to the amount of grafting, the membrane can become too closed off. The water permeable demarcation line for one functionalized nonwoven media used in the Examples can be drawn on an XY graph for dynamic charge capacity MY DCC mg/g versus calculated pore size in μm. The approximate location of the water permeability line will extend through point 1 having a calculated pore size of 5.0 μm and a dynamic charge capacity of 300 MY DCC mg/g and through point 2 having a calculated pore size of 20.6 μm and a dynamic charge capacity of 525 MY DCC mg/g. Functionalized nonwovens having plotted data points above this line tend to be non-water permeable and are less preferred. Functionalized nonwovens having plotted data points below this line tend to be water permeable and are more preferred.

Often the media stack will contain additional functionalized layers, non-functionalized layers, and/or membrane layers. Identical layers may be repeated within the charged depth filter to increase capacity for specific debris sizes before the pore size and/or dynamic charge capacity is changed. The media stack of the charged depth filter can have 2, 3, 4, 5, 6, 7, 8, 9, or 10 or more layers depending on the construction, but will often have less than 25 layers.

The charged depth filter can include an optional membrane layer. The membrane layer is located between the last functionalized layer and housing outlet and can be used to increase capsule back pressure to enhance filtration uniformity. It can be chosen from water permeable membranes including but not limited to polyethersulfone, polysulfone, cellulose, regenerated cellulose, and polyamide membranes.

The charged depth filter can include an optional nonfunctionalized nonwoven layer. The nonfunctionalized nonwoven layer is located between optional membrane layer and housing outlet and can be used to protect membrane integrity during capsule assembly and filtration. The nonfunctionalized nonwoven layer can be chosen from nonwoven materials including but not limited to polypropylene, polyethylene, polymethylpentene, and polyethylene terephthalate materials.

As shown in FIG. 1, a preferred construction for the media stack comprises six layers. A first functionalized nonwoven layer 25 which after grafting has an 18.9 μm effective fiber diameter, a basis weight of 272.7 g/m², a solidity of 13.5%, and a first calculated pore size of 45.6 μm, and a first dynamic charge capacity MY DCC of 291.7 mg/g. The first functionalized nonwoven layer is followed by a repeated first functionalized nonwoven layer 31 having the identical properties, i.e., there are two layers of the first functionalized nonwoven in the charged depth filter. The repeated first functionalized nonwoven layer 31 is followed by a second functionalized nonwoven layer 33. The second functionalized nonwoven layer 33 which after grafting has a 12.1 μm effective fiber diameter, a basis weight of 356.6 g/m², a solidity of 16.3%, and a second calculated pore size of 25.5 μm, and a second dynamic charge capacity MY DCC of 365.3 mg/g. The second functionalized nonwoven layer 33 is followed by a third functionalized nonwoven layer 35. The third functionalized nonwoven layer 35 which after grafting has a 9.1 μm effective fiber diameter, a basis weight of 355.8 g/m², a solidity of 17.8%, and a third calculated pore size of 17.9 μm, and a third dynamic charge capacity MY DCC of 407.4 mg/g. The third functionalized nonwoven layer 35 is followed by a membrane layer 37. The membrane layer is a 0.2 μm PES membrane. The membrane layer 37 is followed by a nonfunctionalized nonwoven layer 39. The nonfunctionalized nonwoven layer 39 is a polypropylene spunbond layer.

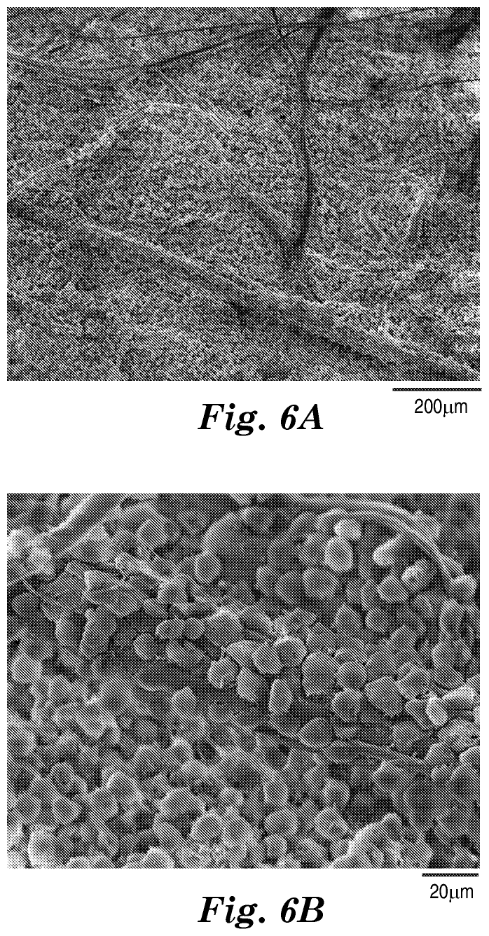

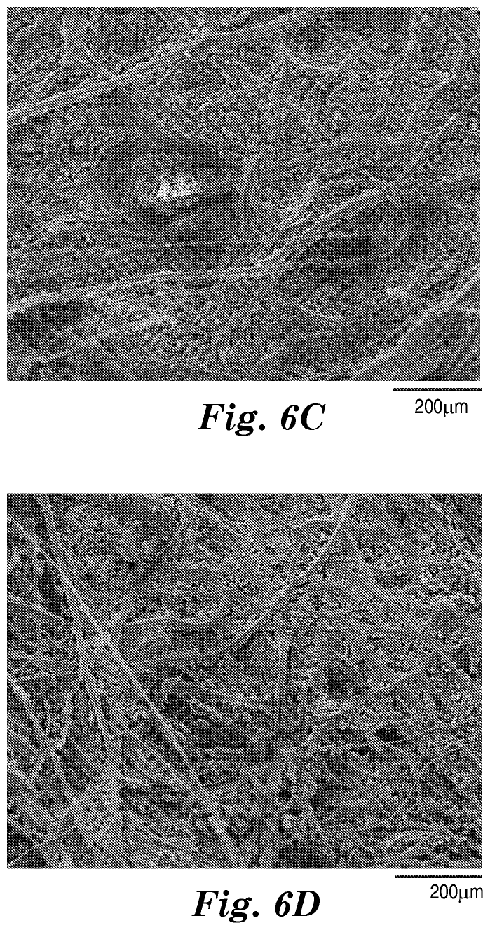

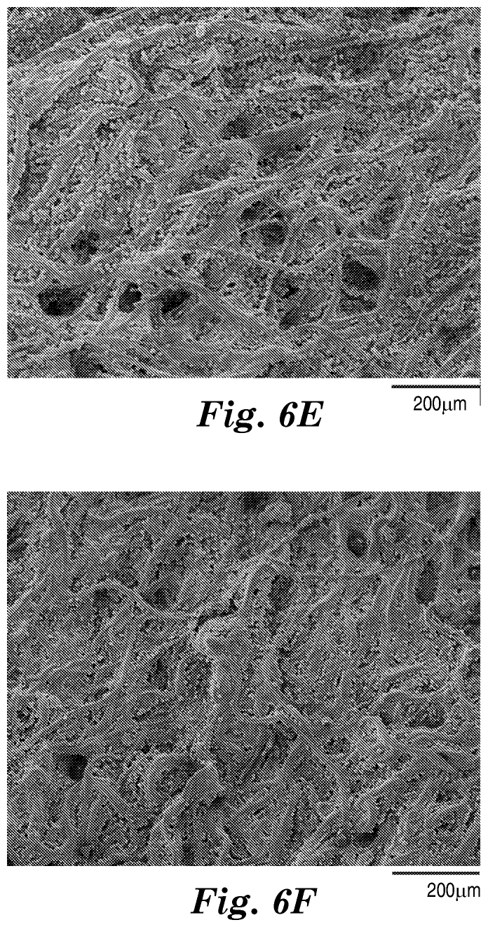

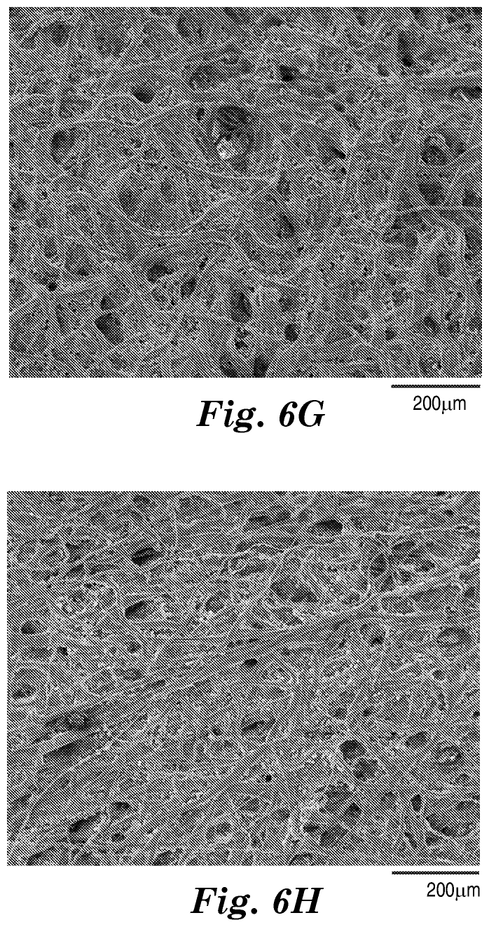

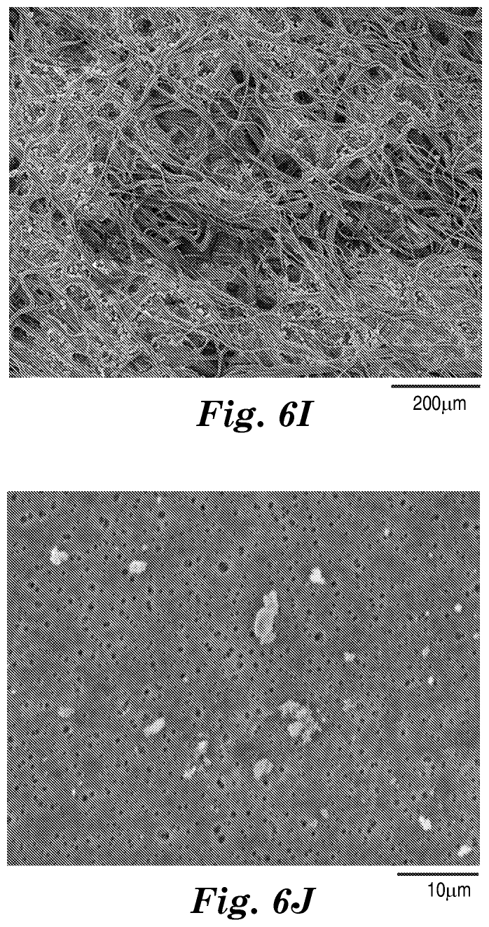

Referring now to FIGS. 6A to 6J, photomicrographs of the various layers in the six-layer construction can be observed after clarifying a CHO cell culture with a 3.2% PCV. As seen, cells, debris, and/or DNA stick to the charged fibers of the functionalized nonwoven layers and look like round balls on the outer surfaces of the fibers. Both the calculated pore size and dynamic charge capacity for each succeeding layer are controlled in such a way so as to not plug or cake the surface of the functionalized nonwoven layers or the membrane layer while still ensuring that each layer in the charged depth filter removes the appropriate size debris as evidenced by both the top and bottom surfaces of the layers having debris stuck to the functionalized grafted fibers. This construction ensures good throughput and removal of debris.

Referring now to FIG. 4, a progression of layers in the media stack for the charged depth filter that are “too open” is shown. As seen, an image of a dissected charged depth filter's media stack of a larger pore functionalized nonwoven, FNW-B, and membrane after cell culture clarification is presented. The cell culture easily penetrates through all four functionalized nonwoven layers (stained portion of discs) and covers the membrane layer's surface with remnants of cells and cell debris. This media stack did not perform well since too many debris fouled the membrane layer (right most circular disc) significantly reducing throughput.

Referring now to FIG. 5, a progression of layers in the media stack for the charged depth filter that are “too tight” is shown. As seen, an image of a dissected charged depth filter's media stack of a smaller pore functionalized nonwoven, FNW-F, and membrane after cell culture clarification is presented. The cell culture fouls the upper functionalized nonwoven layers (stained portion of discs) and cannot penetrate through all the functionalized nonwoven layers (limited to no staining on discs 3 and 4 from left). The third and fourth layers are not utilized, and the membrane layer's surface (right most circular disc) is clean without any remnants of cell and cell debris. This media stack did not perform well since too many debris fouled the initial functionalized nonwoven layers significantly reducing throughput.

### Single Stage Method of Cell Clarification

In biopharmaceutical manufacturing, clarification is the initial processing step aimed to separate and recover the target biomolecule of interest, such as a monoclonal antibody (mAb), virus particle or other therapeutic vector, from a harvested cell culture feedstock by removing cells, cellular debris, and/or colloidal particulates prior to further downstream purification steps. For mammalian cell cultures (e.g., Chinese hamster ovary (CHO) cells, Human embryonic kidney 293 (HEK-293) cells, baby hamster kidney (BHK21) cells, NSO murine myeloma cells, or PER. C6® human cells) size ranges of insoluble contaminants needing to be removed are over 10 microns for whole cells, approximately 1 to 9 microns for cellular debris, and less than 1 micron for colloidal debris. Other target molecules of interest can be produced by insect and bacterial cell lines and the charged depth filter of this inventions can be used to clarify those feedstocks too.

Current process technologies for clarification include, but are not limited to, centrifugation, depth filtration, microfiltration (e.g., tangential flow filtration), or combinations thereof. Due to the wide range contaminant sizes, existing methods for clarification by filtration is achieved in 2 or 3 stages by removing large size particles in a first stage and followed by the removal of smaller particles in a second or third stage. Optimization of these processes or filtration stages to successfully clarify biological therapeutics from cell cultures by filtration depends on characteristics of therapeutic product (e.g., isoelectric point) and cell culture (e.g., cell density, viability, particle size distribution).

Recent advances in cell media, cell engineering, and bioreactor design have led to significant increases in both cell density (e.g., greater than 100 million cells/mL in perfusion-based systems or greater than approximately 20% packed cell volume) and mAb titers (e.g., greater than 10 g/L). This significant increase in cell density brings challenges to the clarification process resulting in lower yield and throughput when using centrifugation and/or conventional depth filtration processes.

Clarification by filtration using a charged depth filter of this invention offers a different mechanism than the conventional size-based exclusion approach employed by conventional depth filters. In the charged depth filter of this invention, whole cells and cellular debris contaminants are removed by both charge-based separation and size exclusion. Chromatographic separation techniques, such as packed resin column chromatography and membrane chromatography, are not designed for this type of application based on their small, porous matrices and operational device designs. Charge-based removal of cells and debris using functionalized nonwovens, presented in this invention, and illustrated in the SEM images in FIGS. 6A to 6J, are not diffusion limited due to high void volume within the functionalized nonwoven matrix. Negatively charged soluble and insoluble contaminants (e.g., cells, debris, DNA, and host cell proteins) in cell culture fluid are removed by electrostatic interaction with the positively-charged surface of the functionalized nonwoven resulting in a one-stage fiber chromatography process.

The charged depth filters described in this disclosure are designed to have a gradient structure based on both the effective pore size and the dynamic charge. The filters can clarify high cell density cultures at 2%-12% packed cell volume PCV (10-60 million cells/mL), more preferably at 3%-11% PCV (15-55 million cells/mL), or more preferably at 3%-9% PCV (15-45 million cells/mL) in a one stage process. During this process the throughput can be at 30-200 L/m² (liters/meter²). Flow rates include 50-600 LMH (liter/meter²/hour), more preferably 75-400 LMH, or more preferably 100-250 LMH. The enhanced throughput capacities for high cell density cultures reduce the manufacturing footprint compared to a conventional depth filter process.

High density cell cultures comprising whole cells and cellular debris typically have a turbidity range between 1,000 to 10,000 nephelometric turbidity units (NTU). The single stage clarification process, using the described charged depth filters, can reduce the turbidity of the high density cell culture down to 50 NTU or less, 20 NTU or less, 15 NTU or less, or 10 NTU of less.

The charged depth filters of the invention are preferably designed to be water permeable and only water is needed for a preconditioning flush. Using water for preconditioning reduces cost and allow for operational ease.

Advantages of a single stage clarification process by the charged depth filters of the invention include, but are not limited to, an increased product yield, a reduced manufacturing footprint, a clarified fluid with consistently lower turbidity, and user-friendly operation. These benefits combined result in preferred process economics for therapeutic drug manufacturing.

### Nonfunctionalized and Functionalized Nonwoven Parameters

Properties of interest for nonfunctionalized nonwovens and functionalized nonwovens (e.g., copolymer grafted nonwovens) include basis weight, effective fiber diameter (EFD), solidity, and pore size. They can be determined for the nonwoven prior to functionalization or after being functionalized.

The fibers of the nonfunctionalized nonwoven substrate typically have an effective fiber diameter of about 3 to 20 micrometers. The nonfunctionalized substrate preferably has basis weight in the range of about 10 to 400 g/m², more preferably about 80 to 250 g/m². The average thickness of the nonfunctionalized substrate is preferably about 0.1 to 10 mm, and more preferably about 0.25 to 5 mm.

The functionalized or nonfunctionalized nonwoven's loft is measured by solidity, a parameter that defines the solids fraction in a volume of web. Lower solidity values are indicative of greater web loft. Solidity is a unitless fraction typically represented by α:

α=m_{f}÷(ρ_{f}×L_{nonwoven})

Basis weight, m_{f}, is the mass (functionalized or nonfunctionalized) per surface area and ρ_{f} is the fiber density (functionalized or nonfunctionalized). L_{nonwoven} is the nonwoven thickness (functionalized or nonfunctionalized). Solidity can be determined for the nonwoven prior to or after functionalization.

Fiber density (ρ_{f}) of copolymer grafted fibers after functionalization is determined by Method A in the Examples described below. Fiber density of copolymer grafted fibers after functionalization can also be determined by a modified version of Method A in which the substrate and copolymer component molar ratios are all obtained from solid state Carbon-13 NMR measurements and the molar ratios are converted to weight ratios. When a nonwoven substrate contains mixtures of two or more kinds of fibers, the individual solidities are determined for each kind of fiber using the same L_{nonwoven} and these individual solidities are added together to obtain the web's solidity, α.

Effective fiber diameter (EFD) is the apparent diameter of the fibers in a nonwoven fibrous web determined by an air permeation test in which air at 1 atmosphere and room temperature is passed at a face velocity of 5.3 cm/sec through a web sample of known thickness, and the corresponding pressure drop is measured. Based on the measured pressure drop, the effective fiber diameter is calculated set forth in Davies, C. N., “The Separation of Airborne Dust and Particles”, Institution of Mechanical Engineers, London, Proceedings 1B, 1952. EFD can be determined for the nonwoven prior to or after functionalization.

The calculated pore size is related to the arithmetic median fiber diameter and web solidity and is determined by the following formula: where D is the calculated pore size, d_{f} is arithmetic median fiber diameter, and α is the web solidity.

$$D = {d}_{f} \{ {( \frac{2 α}{π} )}^{- 1 / 2} - 1 \}$$

Calculated pore size can be determined for the nonwoven prior to or after functionalization. The nonwoven substrate, prior to functionalization, preferably has a calculated pore size of 1-50 micrometers.

The Dynamic Charge Capacity (DCC) of the functionalized nonwoven substrate is determined using a metanil yellow challenge solution using Method B in the Examples and is reported as the MY DCC (Metanil Yellow Dynamic Charge Capacity).

### Nonwoven Base Web

The nonwoven substrate is a nonwoven web which may include nonwoven webs manufactured by any of the commonly known processes for producing nonwoven webs. As used herein, the term “nonwoven web” refers to a fabric that has a structure of individual fibers or filaments which are randomly and/or unidirectionally interlaid in a mat-like fashion. For example, the fibrous nonwoven web can be made by carded, air laid, wet laid, spunlaced, spunbonding, electrospinning or melt-blowing techniques, such as melt-spun or melt-blown, or combinations thereof. Spunbonded fibers are typically small diameter fibers that are formed by extruding molten thermoplastic polymer as filaments from a plurality of fine, usually circular capillaries of a spinneret with the diameter of the extruded fibers being rapidly reduced. Melt-blown fibers are typically formed by extruding the molten thermoplastic material through a plurality of fine, usually circular, die capillaries as molten threads or filaments into high velocity, usually heated gas (e.g., air) stream which attenuates the filaments of molten thermoplastic material to reduce their diameter. Thereafter, the meltblown fibers are carried by the high velocity gas stream and are deposited on a collecting surface to form a web of randomly distributed meltblown fibers. Any of the non-woven webs may be made from a single type of fiber or two or more fibers that differ in the type of thermoplastic polymer and/or thickness.

Suitable polyolefins for making the nonwoven web include, but are not limited to, polyethylene, polypropylene, poly(1-butene), copolymers of ethylene and propylene, alpha olefin copolymers (such as copolymers of ethylene or propylene with 1-butene, 1-hexene, 1-octene, and 1-decene), poly(ethylene-co-1-butene), poly(1-methylpentene) and poly(ethylene-co-1-butene-co-1-hexene). Preferably the nonwoven substrate is a polypropylene.

Further details on the manufacturing method of nonwoven webs of this invention may be found in Wente, Superfine Thermoplastic Fibers, 48 INDUS. ENG. CHEM. 1342(1956), or in Wente et al. Manufacture of Superfine Organic Fibers, (Naval Research Laboratories Reort No.

4364, 1954). Useful methods of preparing the nonwoven substrates are described in U.S. RE39,399 (Allen), U.S. Pat. No. 3,849,241 (Butin et al.), U.S. Pat. No. 7,374,416 (Cook et al.), U.S. Pat. No. 4,936,934 (Buehning), and U.S. Pat. No. 6,230,776 (Choi).

### Functionalized Nonwoven Layer

The functionalized nonwoven layer comprises the nonwoven substrate discussed above and a grafted copolymer comprising interpolymerized monomer units, at least one of which is cationic or can be made cationic in solution of appropriate pH (“cationically ionizable”). A suitable functionalized nonwoven web is disclosed in U.S. Pat. No. 9,821,276 entitled “Nonwoven Article Grafted with Copolymer” issued on Nov. 21, 2017, and herein incorporated by reference.

The cationic or cationically ionizable monomer can include quaternary ammonium-containing monomers and tertiary amine-containing monomers. One or more than one cationic or cationically ionizable monomer may be used. Monomers typically contain polymerizable functionalities as well as cationic or cationically ionizable groups. In certain monomers, the polymerizable group and the cationic group may be the same group. Polymerizable groups include vinyl, vinyl ether, (meth)acryloyl, (meth)acrylamido, allyl, cyclic unsaturated monomers, multifunctional monomers, vinyl esters, and other readily polymerizable functional groups.

Useful (meth)acrylates include, for example, trimethylaminoethylmethacrylate, trimethylaminoethylacrylate, triethylaminoethylmethacylate, triethylaminoethylacrylate, trimethylaminopropylmethacrylate, trimethylaminopropylacrylate, dimethylbutylaminopropylmethacrylate, diethylbutylaminopropylacrylate, 2-(dimethylamino)ethyl methacrylate, 2-(diethylamino)ethyl methacrylate, 2-(dimethylamino)ethyl acrylate, 2-(diethylamino)ethyl acrylate, and 3-(dimethylamino)propyl acrylate.

Exemplary (meth)acrylamides include, for example, 3-(trimethylamino) propylmethacrylamide, 3-(triethylamino)propylmethacrylamide, 3-(ethyldimethylamino)propylmethacrylamide, and n-[3-(dimethylamino)propyl]methacrylamide. Preferred quaternary salts of these (meth)acryloyl monomers include, but are not limited to, (meth)acrylamidoalkyltrimethylammonium salts e.g., 3-methacrylamidopropyltrimethylammonium chloride and 3-acrylamidopropyltrimethylammonium chloride) and (meth)acryloxyalkyltrimethylammonium salts (e.g., 2-acryloxyethyltrimethylammonium chloride, 2-methacryloxyethyltrimethylammonium chloride, 3-methacryloxy-2-hydroxypropyltrimethylammonium chloride, 3-acryloxy-2-hydroxypropyltrimethylammonium chloride, and 2-acryloxyethyltrimethylammonium methyl sulfate).

The grafted copolymer further comprises optional monomer units which can be co-polymerized with the cationic or cationically ionizable monomer(s). While it may be possible to ionize these monomers under certain conditions, they are typically not charged; they are neutral (“neutral monomer”). These neutral monomers have a polymerizable group for use during the graft polymerization. This polymerizable group may be the same as, or different from, the polymerizable group(s) on the cationic or cationically ionizable monomer(s). There may be one or more than one neutral monomer.

Neutral monomers may have a functional group or more than one functional group in addition to the polymerizable group. In the case of neutral monomers with more than one functional group, those functional groups may be the same or different. Some functional groups may enable the neutral monomer to dissolve or disperse in water. Some functional groups may be hydrophilic after polymerizing. Useful functional groups include hydroxyl, alkyl, aryl, ether, ester, epoxy, amide, isocyanate, or cyclic functional groups. Neutral monomers may contain spacer groups between the polymerizing group and the functional group. Neutral monomers may contain oligomeric or polymeric functional group(s). In some embodiments, the polymerizing group and the functional group may be the same group.

Examples of epoxy containing neutral monomers include glycidyl(meth)acrylate, thioglycidyl(meth)acrylate, 3-(2,3-epoxypropoxy)phenyl(meth)acrylate, 2-[4-(2,3-epoxypropoxyl)phenyl]-2-(4-(meth)acryloyloxy-phenyl)propane, 4-(2,3-epoxypropoxyl)cyclohexyl(meth)acrylate, 2,3-epoxycyclohexyl(meth)acrylate, and 3,4-epoxycyclohexyl(meth)acrylate, and combinations thereof. Examples of hydroxyl containing monomers include N-hydroxyethyl(meth)acrylate, poly(ethylene glycol)(meth)acrylates, poly(propylene glycol)(meth)acrylates, N-hydroxyethyl(meth)acrylamide, 2-hydroxypropyl(meth)acrylamide, N-hydroxypropyl(meth)acrylate, 2-hydroxy-3-phenoxypropyl(meth)acrylate, and combinations thereof. Examples of suitable amide monomers include N-vinyl caprolactam, N-vinyl acetamide, N-vinyl pyrrolidone, (meth)acrylamide, mono- or di-N-alkyl substituted acrylamide, and combinations thereof. Examples of suitable ether monomers include poly(ethylene glycol)(meth)acrylates, poly(propylene glycol)(meth)acrylates, 2-ethoxyethyl (meth)acrylate, ethylene glycol methyl ether (meth)acrylate, N-3-methoxypropyl(meth)acrylamide, di(ethylene glycol)methyl ether(meth)acrylate, poly(ethylene glycol)phenyl ether (meth)acrylate, 2-pheoxyethyl(meth)acrylate, other alkyl ether (meth)acrylates and alkyl ether (meth)acrylamides, tetrahydrofurfuryl(meth)acrylate, and combinations thereof.

The process of preparing the functionalized nonwoven layer includes the steps of providing a nonwoven substrate, exposing the nonwoven substrate to ionizing radiation in an inert atmosphere, and subsequently contacting the exposed substrate with a solution or suspension comprising the grafting monomers to graft polymerize said monomers to the nonwoven substrate.

In the first step the nonwoven substrate is exposed to ionizing radiation in an inert atmosphere. Exemplary forms of ionizing radiation include electron beam (e-beam), gamma, x-ray, and other forms of electromagnetic radiation. The inert atmosphere is generally an inert gas such as nitrogen, carbon dioxide, helium, argon, etc. with a minimal amount of oxygen. Doses delivered by the ionizing radiation source may happen in a single dose or may be in multiple doses which accumulate to the desired level. One or more layers of nonwoven substrates may be subjected to the ionizing radiation

After the irradiation step, the irradiated nonwoven substrate is contacted with the aqueous monomer solution or suspension. “Contacted” means bringing the irradiated nonwoven substrate into contact with the monomer solution or suspension. It can also be described as the irradiated nonwoven substrate being saturated, imbibed, or coated with monomer solution. The monomer solution may only partially fill the void volume of the nonwoven substrate, or much more solution can be contacted to the nonwoven substrate than is necessary to fully fill the void volume. The monomer contact step also occurs in an inert atmosphere. This atmosphere may be the same as, or different from, the atmosphere in the chamber where the substrate is irradiated. The chamber may be the same as, or different from, the chamber where the substrate is irradiated. The monomer solution remains in contact with the nonwoven substrate for a time sufficient for the graft polymerization with some, most, or substantially all the monomers in the monomer solution. Once the nonwoven substrate has been contacted for a desired period of time, the nonwoven substrate bearing grafted polymer may be removed from the inert atmosphere.

### EXAMPLES

TABLE 1
Materials

| Description (abbreviation) | Source |
|---|---|
| 3-methacrylamidopropyltrimethylammonium | Evonik Corporation, |
| chloride (MAPTAC) (50 weight % in water) | Parsippany, NJ |
| [CAS No. 51410-72-1] | |
| N-viny1-2-pyrrolidone (NVP) | Ashland Chemicals, |
| | Covington, KY |
| Glycidyl methacrylate (GMA) | Dow Chemical, |
| | Midland, MI |

### Grafting Solutions

Grafting Solution A was prepared as a monomer solution containing 24.4% NVP, 8.8% GMA, and 19.4% MAPTAC all by weight in deionized water.

Grafting Solution B was prepared as a monomer solution containing 18.3% NVP, 6.6% GMA, and 14.6% MAPTAC all by weight in deionized water.

Grafting Solution C was prepared as a monomer solution containing 12.2% NVP, 4.4% GMA, and 9.7% MAPTAC all by weight in deionized water.

### Method A. Determination of Basis Weight, Effective Fiber Diameter (EFD), Solidity, and Pore Size of Functionalized Nonwovens

Basis weight, EFD, solidity, and pore size measurements of the functionalized nonwovens were determined according to the following procedure. Sample discs (13.33 cm diameter) were punched from functionalized nonwoven sheets and then individually rinsed by submerging each disc in a 2 L bath of deionized water for 15 minutes. The rinse procedure was repeated three additional times using fresh deionized water for each rinse step. Each rinsed disc was dried in an oven at 70° C. for at least 4 hours. During the drying step, a weight (about 100 g) was placed on top of each disc to prevent edge curling. The resulting dried functionalized nonwoven samples were characterized (basis weight, EFD, solidity, pore size) according to the methods and equations described above. For each measurement or calculation, the results were reported as the mean value of three independent trials (n=3) with the calculated standard deviation (SD).

For the solidity (a) equation, the fiber density (ρ_{f}) measurement was determined as the sum of the density of the polypropylene substrate (0.91 g/cm³) and the density of the grafted copolymer (1.07 g/cm³) adjusted by the weight ratio of the polypropylene substrate and grafted copolymer of the test sample (Equation 1). The polypropylene substrate and copolymer weight ratios were determined by comparing the basis weight of the nonwoven before the grafting step to the basis weight of the corresponding dried functionalized nonwoven.

The density of the grafted copolymer (D_{GCP}) was determined by first using solid state ¹³C NMR (ssNMR) to measure the mol % of monomer components (NVP, MAPTAC, GMA) of the grafted copolymer, converting the mol % values to weight % (wt. %) values. The density value of each monomer component (monomer densities: D_{NVP}=1.04 g/cm³, D_{MAPTAC}=1.067 g/cm³, D_{GMA}=1.07 g/cm³) was adjusted (multiplied) by the corresponding component wt. % value, and the resulting three adjusted density values were summed (Equation 2).

Fiber density (ρ_{f})=(0.91×wt. %_{polypropylene})+(1.05×wt. %_{grafted copolymer}) Equation 1

D_{GCP}=(D_{NVP}×wt. %_{NVP})+(D_{MAPTAC}×wt. %_{MAPTAC})+(D_{GMA}×wt. %_{GMA}) Equation 2

### Method B. Determination of the Metanil Yellow Dynamic Charge Capacity (MY DCC) of Functionalized Nonwovens

Functionalized nonwoven discs were prepared according to Method A. The dynamic charge capacity of a disc was determined using the charged organic dye metanil yellow as the target molecule of the challenge solution. The challenge solution used had a metanil yellow concentration of 160 mg/L (160 ppm). The challenge solution was prepared by dissolving 3.2 g of metanil yellow, 93.98 g of sodium phosphate dibasic anhydrous, 46.64 g of sodium phosphate monobasic monohydrate and 163.63 g of NaCl in 20 L of deionized water. The challenge solution was used within 2 days of preparation. If needed, the amount of metanil yellow reagent used to prepare the challenge solution was adjusted based on the purity of the regent so that the challenge solution contained 160 ppm of metanil yellow. An analytical standard grade metanil yellow (≥98.0%, product #44426 from the Sigma-Aldrich Company, St. Louis, MO) was used to calibrate reagent purity. A buffer solution for pre-conditioning the test assembly was also prepared having the same formulation as the challenge solution except that metanil yellow was not included.

The filtration test assembly contained a clear, polycarbonate body section (47 mm inner diameter) with a screw-on cap attached to the top of the body section. The cap contained an inlet port and a vent port. The bottom of the body section contained an outlet port with a stopcock. A pressure sensor was placed upstream of the inlet port. A polyamide membrane (0.2 micrometer grade) was placed at the bottom of the body section. A stack containing two functionalized nonwoven discs (each 47 mm diameter and punched from a disc prepared according to Method A) was placed in the assembly on top of the membrane. In the assembly, the nonwoven discs were sandwiched between two PTFE seal rings each containing a knife edge on the inner diameter to bite into the nonwoven. The resulting sub-assembly was secured in place using an O-ring. The frontal surface area of the disc stack was 0.00097 m². The cap was attached to the body section and a PendoTech normal flow filtration system (PendoTech Company, Princeton, NJ) was connected to the inlet port. A Hach Model 2100AN turbidimeter (Hach Company, Loveland, CO) with a 455 nm light filter, and a flow-through cell was connected to the output port and used to measure the metanil yellow concentration in the filtrate. Metanil yellow solutions with concentration of 0.8 ppm, 4 ppm, and 8 ppm were prepared as test standards. The end point of the charge capacity measurement was set at the 5% break-through (8 ppm) of metanil yellow solution. The fluid flow rate was 15 mL/minute. Prior to pumping the challenge solution, the preconditioning buffer was flushed through the assembly for about 5 minutes.

The volume of challenge solution that passed through the test assembly up to the end point (i.e., the breakthrough volume) was measured and the dynamic charge capacity (mg/g) of the functionalized nonwoven sample was calculated according to Equation 3. For each functionalized nonwoven, MY DCC was reported as the mean value from three independent trials (n=3) with the calculated standard deviation (SD).

$$MY DCC = \frac{\begin{matrix}Breakthrough volume ( mL ) \times \\ Mentanil Yellow concentration ( mg / mL )\end{matrix}}{\begin{matrix}Total Basis weight of FNW ( g / m 2 ) \times \\ FNW disc frontal surface area ( m 2 )\end{matrix}} \qquad Equation 3$$

### Method C. Preparation of Harvested Cell Culture Fluid (HCCF)—Chinese Hamster Ovary (CHO) Cell Culture

CHO cells were cultured in suspension from frozen cell stock to a series of flask seeding cultures in a CO₂ incubator, followed by a fed-batch culture process using a Wave bioreactor (GE Healthcare, Chicago, IL) and a 50 L disposable cell bag with pH control and dissolved oxygen monitoring. Cell culture media was obtained from Fujifilm Irvine Scientific (Santa Ana, CA). CHO cell cultures were harvested during stationary phase, typically on day 12.

Viable cell density and viability were measured using a hemocytometer. The harvested cell culture fluid was mixed with 10% (vol/vol) trypan blue solution and then loaded to a disposable hemocytometer. Viable and dead cells were counted under microscopy. Packed Cell Volume Percentage (% PCV) was measured using a PCV tube (product #Z760986, Sigma-Aldrich Company) with 200 microliters of harvested cell culture fluid (HCCF) added to the PCV tube. The tube was centrifuged at 2500 relative centrifugal force (rcf) for one minute. The % PCV was calculated by volume of solid over volume of HCCF.

### Method D. Clarification of Harvested Cell Culture Fluid (HCCF)

Filter housing capsules (FIG. 7) were tested for HCCF clarification with a PendoTech normal flow filtration system (PendoTech Company) connected to the capsule via the Luer lock inlet of the capsule. The plastic filter capsule had an upper housing and a lower housing that were mated together in the final construction by ultrasonic welding. The upper housing had a Luer lock inlet port and a Luer lock vent. The lower housing had a Luer lock outlet port centered in the middle of the lower housing. A disc (2.54 cm diameter) of TYPAR 3161L polypropylene spunbond nonwoven (10 mil thick, obtained from Fiberweb, Inc., Old Hickory, TN) was placed in the bottom of the lower housing. A disc (2.54 cm diameter) of a MICRO-PES Flat Type 2F polyethersulfone membrane with a 0.2 micrometer nominal pore size (obtained from the 3M Company, St. Paul, MN) was placed on top of the nonwoven layer. The nonwoven and membrane layers were ultrasonically welded at the margins to the bottom inner surface of the lower housing. A stack of four functionalized nonwoven layers (2.54 cm diameter discs) was then placed on top of the membrane. A polypropylene spacer ring (25.4 mm OD, 21.84 mm ID, 50 mil thick) was inserted between the second and third nonwoven layers. The upper and lower housings were mated together and ultrasonically welded to form a finished filter capsule. The ultrasonic welding was accomplished by placing the mated assembly in a jig so that the outer surface of the lower housing came into contact with the ultrasonic horn. A Branson 20 kHz Ultrasonic welder (Model 2000xdt, Emerson Electric Company, St. Louis, MO), a black booster, and a horn with a gain of 2.5× was used. An air pressure of 80 psi, down speed of 10%, stepped amplitude of 80%-60%, stepped at 50 Joules, weld time of 2 second, and a trigger force of 200 lbf to start welding were set as fixed parameters. The weld energy was held constant at 450 Joules to produce samples with consistent compression levels. The housing assembly was positioned below the horn so that housing longitudinal axis was aligned to the axis of the ultrasonic horn. When the welding process is initiated, the horn came down on the lower housing compressing the housing and the internal components until a force of 200 lbf was reached. The overall outer diameter of the finished capsule was about 3.7 cm and the overall height including inlet, outlet, and vent ports was about 4.8 cm. The frontal surface area for the disc stack was 3.2 cm².

The HCCF was stirred thoughout the procedure. At the start of the filtration, the filter capsule headspace was filled with HCCF at the specified flow rate by opening the vent and closing the outlet. After the headspace of the capsule was filled with HCCF, the vent was closed and the outlet was opened to allow for collection of clarified cell culture fluid (CCCF). The differential pressure was monitored during the clarification process. Clarification was stopped once the differential pressure reached 5 psid (pounds per square inch differential). The collected CCCF volume and CCCF turbidity were recorded. Throughput (L/m²) was calculated based on CCCF volume collected per unit surface area of the filter. Turbidity of the filtrate was measured in nephelometric turbidity units (NTU) using an Orion AQ4500 turbidity meter (Thermo Fisher Scientific, Waltham, MA).

### Method E. Preparation of AAV2 Feed Solution

HEK293-F cells suspended in Gibco LV-MAX Production Medium (Thermo Fisher Scientific, Waltham, MA) were grown in an incubator using 2.8 L shaker flasks with shaking at a constant rate of 90 rpm (revolutions per minute). The incubator was maintained at 37° C. with 8% CO₂. When the cell density reached approximately 2×10⁶ cells/mL, a transfection cocktail was prepared and administered to the shaker flask.

The transfection cocktail consisted of the plasmids pAAV2-RC2 Vector (Part No. VPK-422), pHelper Vector (Part No. 340202), (plasmids obtained from Cell Biolabs, San Diego, CA), and FECTOVIR®-AAV transfection reagent (Polyplus Transfection, New York, NY). The transfection cocktail was prepared by first adding pHelper Vector and pAAV2-RC2 Vector at a molar ratio of 62% to 38% and the total plasmid amount was adjusted to be one microgram of plasmid mixture per million HEK cells used for transfection. Next, DMEM (Dulbecco's Modified Eagle Medium, obtained from Thermo Fisher Scientific) was added to the cocktail so that a final concentration of 5% DMEM (volume/volume) was achieved after adding the cocktail to the cell culture flask (i.e., volume/volume calculations for DMEM were adjusted based on the total cell culture volume). After the addition of DMEM, the cocktail was mixed and then one microliter of FectoVIR-AAV transfection reagent was added for every microgram of the plasmid mixture in the cocktail. The cocktail was gently mixed followed by incubation at room temperature for 45 minutes. Following the incubation step, the completed transfection cocktail was gently mixed and then added dropwise to the flask containing the cell culture. After addition of the transfection cocktail, the cells were grown in the incubator (37° C. with 8% CO₂) for 72-96 hours to induce the production of AAV2.

Cell viability was measured using a hemocytometer. The harvested cell culture fluid was mixed with 25% (volume/volume) trypan blue solution and then loaded to a disposable hemocytometer. Viable and dead cells were counted under microscopy. The turbidity measurement of the transfected cell culture was determined in nephelometric turbidity units (NTU) using an ORION AQ4500 turbidity meter (Thermo Fisher Scientific). The AAV2 transfected cell culture had a cell density value of 6.2×10⁶ cells/mL, a cell viability of 74%, and turbidity of 560 NTU.

The transfected cell culture was charged with TRITON X-100 detergent (obtained from the Promega Corporation, Madison, WI) to achieve a final detergent concentration of 0.1 wt. % and then shaken at 90 rpm for 2 hours in an incubator (set at 37° C., 8% CO₂). The conductivity of the lysed sample was adjusted to 20 mS/cm using a 5M sodium chloride solution. Conductivity was measured using a calibrated Orion Star A215 pH/Conductivity Benchtop Multiparameter Meter (Thermo Fisher Scientific). Following cell lysis, the resulting AAV2 feed solution had an AAV2 capsid content of 8.5×10¹¹ capsids/mL, total DNA content of 4230 ng/mL, and turbidity of 165 NTU.

The AAV2 capsid content of both the feed solution before filtration and the filtrate obtained after filtration were measured using a ProGen AAV2 Xpress ELISA kit (obtained from American Research Products, Inc., Waltham, MA) according to the manufacturer's instructions. The DNA concentration of both the feed solution before filtration and the filtrate obtained after filtration were measured using the QUANT-IT PICOGREEN dsDNA assay (Thermo Fisher Scientific) according to the manufacturer's instructions.

### Preparation of Functionalized Nonwoven A (FNW-A)

A nonfunctionalized melt-blown polypropylene microfiber nonwoven web (having an effective fiber diameter (EFD) of 16 micrometers, basis weight of 200 grams per square meter (gsm), solidity of 10%, and calculated average pore size of 47.4 micrometers) was grafted with nitrogen purged Grafting Solution C. The nonwoven substrate was unwound and passed through an electron beam (Electrocure, from Energy Science, Inc, Wilmington, MA) set to a potential of 300 kV and to deliver a total dose of 7 Mrad. The environment in the electron beam chamber was purged with nitrogen. The web was then conveyed directly into a nitrogen-purged saturation step with the monomer solution. The web was then wound up within the purged atmosphere. The web was left in the purged atmosphere for a minimum of 60 minutes, after which it was exposed to air. The web was then unwound and conveyed into a tank of deionized water for about 8 minutes at a speed of 10 feet per minute. After exiting the tank, the web was flushed multiple time by passing an aqueous salt solution (NaCl) through the web using a vacuum belt. A small amount of glycerin was added to the aqueous salt solution in the final flushing step. The unwound web was dried until the moisture content of the web was less than 14% by mass. The web was then wound up on a spindle. The grafted article was labeled as Functionalized Nonwoven A (FNW-A). The properties of FNW-A are reported in TABLE 2. Discs of FNW-A (2.54 cm diameter) were punched from the web.

### Preparation of Functionalized Nonwoven B (FNW-B)

A nonfunctionalized melt-blown polypropylene microfiber nonwoven web (having an effective fiber diameter of 14 micrometers, basis weight of 200 gsm, solidity of 10%, calculated average pore size of 41.5 micrometers) was grafted using same procedure described for FNW-A. The grafted article was labeled as Functionalized Nonwoven B (FNW-B). The properties of FNW-B are reported in TABLE 2. Discs of FNW-B (2.54 cm diameter) were punched from the web.

### Preparation of Functionalized Nonwoven C (FNW-C)

A nonfunctionalized melt-blown polypropylene microfiber nonwoven web (having an effective fiber diameter of 12 micrometers, basis weight of 200 gsm, solidity of 10%, calculated average pore size of 35.6 micrometers) was grafted using same procedure described for FNW-A. The grafted article was labeled as Functionalized Nonwoven C (FNW-C). The properties of FNW-C are reported in TABLE 2. Discs of FNW-C (2.54 cm diameter) were punched from the web.

### Preparation of Functionalized Nonwoven D (FNW-D)

A nonfunctionalized melt-blown polypropylene microfiber nonwoven web (having an effective fiber diameter of 10 micrometers, basis weight of 200 gsm, solidity of 10%, calculated average pore size of 29.6 micrometers) was grafted using same procedure described for FNW-A. The grafted article was labeled as Functionalized Nonwoven D (FNW-D). The properties of FNW-D are reported in TABLE 2. Discs of FNW-D (2.54 cm diameter) were punched from the web.

### Preparation of Functionalized Nonwoven E (FNW-E)

A nonfunctionalized melt-blown polypropylene microfiber nonwoven web (having an effective fiber diameter of 8 micrometers, basis weight of 200 gsm, solidity of 10%, calculated average pore size of 23.7 micrometers) was grafted using same procedure described for FNW-A. The grafted article was labeled as Functionalized Nonwoven E (FNW-E). The properties of FNW-E are reported in TABLE 2. Discs of FNW- E (2.54 cm diameter) were punched from the web.

### Preparation of Functionalized Nonwoven F (FNW-F)

A nonfunctionalized melt-blown polypropylene microfiber nonwoven web (having an effective fiber diameter of 6 micrometers, basis weight of 200 gsm, solidity of 10%, calculated average pore size of 17.8 micrometers) was grafted using same procedure described for FNW-A. The grafted article was labeled as Functionalized Nonwoven F (FNW-F). The properties of FNW-F are reported in TABLE 2. Discs of FNW-F (2.54 cm diameter) were punched from the web.

### Preparation of Functionalized Nonwoven G (FNW-G)

A nonfunctionalized melt-blown polypropylene microfiber nonwoven web (having an effective fiber diameter of 4.2 micrometers, basis weight of 100 gsm, solidity of 8.2%, calculated average pore size of 14.2 micrometers) was grafted using same procedure described for FNW-A. The grafted article was labeled as Functionalized Nonwoven G (FNW-G). The properties of FNW-G are reported in TABLE 2. MY DCC was determined by Method B using 4 discs of functionalized nonwoven instead of 2 discs. Discs of Functionalized Nonwoven G (2.54 cm diameter) were punched from the web.

TABLE 2
Properties of Functionalized Nonwovens A-G

| | Graft | EFD | Basis Wt. | Solidity | Pore Size | Water | MY DCC |
|---|---|---|---|---|---|---|---|
| FNW | Soln. | (μm) | (gsm) | (%) | (μm) | Permeable | (mg/g) |
| A | C | 23.5 ± 0.2 | 267.1 ± 6.5 | 13.2 ± 0.7 | 57.7 ± 1.5 | Yes | 169.4 ± 25.8 |
| B | C | 21.6 ± 0.3 | 302.0 ± 5.1 | 14.2 ± 0.3 | 50.5 ± 0.6 | Yes | 165.0 ± 2.6 |
| C | C | 18.9 ± 1.2 | 272.7 ± 5.3 | 13.5 ± 0.6 | 45.6 ± 3.0 | Yes | 291.7 ± 20.4 |
| | | (12 um) | | | | | |
| D | C | 14.6 ± 0.1 | 304.2 ± 3.3 | 14.4 ± 0.3 | 33.7 ± 0.4 | Yes | 316.0 ± 12.8 |
| E | C | 12.1 ± 0.3 | 356.6 ± 3.4 | 16.3 ± 0.7 | 25.5 ± 0.3 | Yes | 365.3 ± 10.5 |
| | | (8 um) | | | | | |
| F | C | 9.1 ± 0.3 | 355.8 ± 11.4 | 17.8 ± 0.6 | 17.9 ± 0.2 | Yes | 407.4 ± 26.6 |
| | | (6 um) | | | | | |
| G | C | 8.1 ± 0.2 | 318.5 ± 6.3 | 24.6 ± 0.1 | 12.4 ± 0.3 | No | 443.2 ± 28.1 |

### Preparation of Functionalized Nonwoven H (FNW-H)

A nonfunctionalized melt-blown polypropylene microfiber nonwoven web (having an effective fiber diameter of 14 micrometers, basis weight of 200 gsm, solidity of 10%, calculated average pore size of 41.5 micrometers) was grafted using same procedure described for FNW-A with the exception that Grafting Solution B was used, instead of Grafting Solution C. The grafted article was labeled as Functionalized Nonwoven H (FNW-H). The properties of FNW-H are reported in TABLE 3. Discs of FNW-H (2.54 cm diameter) were punched from the web.

### Preparation of Functionalized Nonwoven I (FNW-I)

A nonfunctionalized melt-blown polypropylene microfiber nonwoven web (having an effective fiber diameter of 12 micrometers, basis weight of 200 gsm, solidity of 10%, calculated average pore size of 35.6 micrometers) was grafted using same procedure described for FNW-A with the exception that Grafting Solution B was used, instead of Grafting Solution C. The properties of FNW-I are reported in TABLE 3. Discs of FNW-I (2.54 cm diameter) were punched from the web.

### Preparation of Functionalized Nonwoven J (FNW-J)

A nonfunctionalized melt-blown polypropylene microfiber nonwoven web (having an effective fiber diameter of 10 micrometers, basis weight of 200 gsm, solidity of 10%, calculated average pore size of 29.6 micrometers) was grafted using same procedure described for FNW-A with the exception that Grafting Solution B was used, instead of Grafting Solution C. The grafted article was labeled as Functionalized Nonwoven J (FNW-J). The properties of FNW-J are reported in TABLE 3. Discs of FNW-J (2.54 cm diameter) were punched from the web.

### Preparation of Functionalized Nonwoven K (FNW-K)

A nonfunctionalized melt-blown polypropylene microfiber nonwoven web (having an effective fiber diameter of 8 micrometers, basis weight of 200 gsm, solidity of 10%, calculated average pore size of 23.7 micrometers) was grafted using same procedure described for FNW-A with the exception that Grafting Solution B was used, instead of Grafting Solution C. The grafted article was labeled as Functionalized Nonwoven K (FNW-K). The properties of FNW-K are reported in TABLE 3. Discs of FNW-K (2.54 cm diameter) were punched from the web.

### Preparation of Functionalized Nonwoven L (FNW-L)

A nonfunctionalized melt-blown polypropylene microfiber nonwoven web (having an effective fiber diameter of 6 micrometers, basis weight of 200 gsm, solidity of 10%, calculated average pore size of 17.8 micrometers) was grafted using same procedure described for FNW-A with the exception that Grafting Solution B was used, instead of Grafting Solution C. The grafted article was labeled as Functionalized Nonwoven L (FNW-L). The properties of FNW-L are reported in TABLE 3. Discs of FNW-L (2.54 cm diameter) were punched from the web.

### Preparation of Functionalized Nonwoven M (FNW-M)

A nonfunctionalized melt-blown polypropylene microfiber nonwoven web (having an effective fiber diameter of 4.2 micrometers, basis weight of 100 gsm, solidity of 8.2%, calculated average pore size of 14.2 micrometers) was grafted using same procedure described for FNW-A with the exception that Grafting Solution B was used, instead of Grafting Solution C. The grafted article was labeled as Functionalized Nonwoven M (FNW-M). The properties of FNW-M are reported in TABLE 3. MY DCC was determined by method B using 4 discs of functionalized nonwoven instead of 2 discs. Discs of Functionalized Nonwoven M (2.54 cm diameter) were punched from the web.

TABLE 3
Properties of Functionalized Nonwovens H-M

| | Graft | EFD | Basis Wt. | Solidity | Pore Size | Water | My DCC |
|---|---|---|---|---|---|---|---|
| FNW | Soln. | (μm) | (gsm) | (%) | (μm) | Permeable | (mg/g) |
| H | B | 25.9 ± 0.4 | 320.2 ± 7.0 | 14.0 ± 0.3 | 60.9 ± 1.8 | Yes | 172.2 ± 20.4 |
| I | B | 20.6 ± 0.5 | 311.3 ± 7.5 | 13.7 ± 1.0 | 49.2 ± 2.4 | Yes | 305.2 ± 18.4 |
| J | B | 17.3 ± 0.2 | 363.8 ± 6.3 | 15.7 ± 0.5 | 37.5 ± 0.4 | Yes | 409.8 ± 6.6 |
| K | B | 14.5 ± 0.6 | 438.3 ± 10.1 | 18.1 ± 0.7 | 28.2 ± 0.3 | Yes | 415.8 ± 15.2 |
| L | B | 11.4 ± 0.4 | 519.4 ± 11.3 | 19.4 ± 0.4 | 21.1 ± 0.5 | No | 513.5 ± 28.2 |
| M | B | 8.3 ± 0.4 | 350.9 ± 8.6 | 23.4 ± 1.1 | 13.2 ± 0.1 | No | 584.3 ± 8.1 |

### Preparation of Functionalized Nonwoven N (FNW-N)

A nonfunctionalized melt-blown polypropylene microfiber nonwoven web (having an effective fiber diameter of 14 micrometers, basis weight of 200 gsm, solidity of 10%, calculated average pore size of 41.5 micrometers) was grafted using same procedure described for FNW-A with the exception that Grafting Solution A was used, instead of Grafting Solution C. The grafted article was labeled as Functionalized Nonwoven N (FNW-N). The properties of FNW-N are reported in TABLE 4. Discs of FNW-N (2.54 cm diameter) were punched from the web.

### Preparation of Functionalized Nonwoven O (FNW-O)

A nonfunctionalized melt-blown polypropylene microfiber nonwoven web (having an effective fiber diameter of 12 micrometers, basis weight of 200 gsm, solidity of 10%, calculated average pore size of 35.6 micrometers) was grafted using same procedure described for FNW-A with the exception that Grafting Solution A was used, instead of Grafting Solution C. The grafted article was labeled as Functionalized Nonwoven O (FNW-O). The properties of FNW-O are reported in TABLE 4. Discs of FNW-O (2.54 cm diameter) were punched from the web.

### Preparation of Functionalized Nonwoven P (FNW-P)

A nonfunctionalized melt-blown polypropylene microfiber nonwoven web (having an effective fiber diameter of 10 micrometers, basis weight of 200 gsm, solidity of 10%, calculated average pore size of 29.6 micrometers) was grafted using same procedure described for FNW-A with the exception that Grafting Solution A was used, instead of Grafting Solution C. The grafted article was labeled as Functionalized Nonwoven P (FNW-P). The properties of FNW-P are reported in TABLE 4. Discs of FNW-P (2.54 cm diameter) were punched from the web.

### Preparation of Functionalized Nonwoven Q (FNW-Q)

A nonfunctionalized melt-blown polypropylene microfiber nonwoven web (having an effective fiber diameter of 8 micrometers, basis weight of 200 gsm, solidity of 10%, calculated average pore size of 23.7 micrometers) was grafted using same procedure described for FNW-A with the exception that Grafting Solution A was used, instead of Grafting Solution C. The grafted article was labeled as Functionalized Nonwoven Q (FNW-Q). The properties of FNW-Q are reported in TABLE 4. Discs of FNW-Q (2.54 cm diameter) were punched from the web.

### Preparation of Functionalized Nonwoven R (FNW-R)

A nonfunctionalized melt-blown polypropylene microfiber nonwoven web (having an effective fiber diameter of 6 micrometers, basis weight of 200 gsm, solidity of 10%, calculated average pore size of 17.8 micrometers) was grafted using same procedure described for FNW-A with the exception that Grafting Solution A was used, instead of Grafting Solution C. The grafted article was labeled as Functionalized Nonwoven R (FNW-R). The properties of FNW-R are reported in TABLE 4. Discs of FNW-R (2.54 cm diameter) were punched from the web.

### Preparation of Functionalized Nonwoven S (FNW-S)

A nonfunctionalized melt-blown polypropylene microfiber nonwoven web (having an effective fiber diameter of 4.2 micrometers, basis weight of 100 gsm, solidity of 8.2%, calculated average pore size of 14.2 micrometers) was grafted using same procedure described for FNW-A with the exception that Grafting Solution A was used, instead of Grafting Solution C. The grafted article was labeled as Functionalized Nonwoven S (FNW-S). The properties of FNW-S are reported in TABLE 4. MY DCC was determined by Method B using 4 discs of functionalized nonwoven instead of 2 discs. Discs of Functionalized Nonwoven G (2.54 cm diameter) were punched from the web.

TABLE 4
Properties of Functionalized Nonwovens N-S

| | Graft | EFD | Basis Wt. | Solidity | Pore Size | Water | My DCC |
|---|---|---|---|---|---|---|---|
| FNW | Soln. | (μm) | (gsm) | (%) | (μm) | Permeable | (mg/g) |
| N | A | 25.0 ± 0.3 | 336.5 ± 9.4 | 13.2 ± 0.3 | 61.5 ± 0.5 | Yes | 197.6 ± 22.6 |
| O | A | 20.7 ± 0.4 | 325.6 ± 10.9 | 13.7 ± 0.5 | 49.6 ± 1.7 | Yes | 325.6 ± 20.3 |
| P | A | 18.7 ± 0.4 | 384.6 ± 2.9 | 15.5 ± 0.1 | 40.8 ± 1.1 | Yes | 449.2 ± 6.7 |
| Q | A | 16.3 ± 0.7 | 487.4 ± 10.3 | 18.9 ± 0.2 | 30.7 ± 1.7 | Yes | 465.5 ± 19.1 |
| R | A | 12.7 ± 0.5 | 540.3 ± 6.0 | 21.8 ± 1.0 | 21.4 ± 0.4 | No | 509.5 ± 11.7 |
| S | A | 9.2 ± 0.5 | 358.3 ± 7.8 | 24.3 ± 0.9 | 14.3 ± 0.6 | No | 604.5 ± 6.3 |

### Example (Ex 1)

A filtration capsule was assembled as described in Method D using two discs of FNW-B and two discs of FNW-F. The orientation of discs from capsule inlet to outlet was two discs of FNW-B followed by two discs of FNW-F. A Chinese Hamster Ovary (CHO) cell culture fluid was prepared to evaluate the filtration performance of the assembled capsule (described above). The harvested cell culture fluid (HCCF) had a packed cell volume percentage (% PCV) of 3.2%, viability of 25.5%, and turbidity of 1879 NTU. The capsule was tested according to Method D (described above) at a flow rate of 200 liters per square meter per hour (LMH). The resulting clarified cell culture fluid (CCCF) was collected until the differential pressure cross capsule reached 5 psi. The throughput was 44.4 L/m² and the CCCF turbidity was 3.15 NTU.

### Example 2 (Ex 2)

A filtration capsule was assembled as described in Method D using two discs of FNW-B and two discs of FNW-G. The orientation of discs from capsule inlet to outlet was two discs of FNW-B followed by two discs of FNW-G. The filtration performance of the assembled capsule was determined using the procedure and HCCF described in Example 1. The throughput was 30.3 L/m² and the CCCF turbidity was 2.98 NTU.

### Example 3 (Ex 3)

A filtration capsule was assembled as described in Method D using two discs of FNW-B, one disc of FNW-D, and one disc of FNW-E. The orientation of discs from capsule inlet to outlet was FNW-B/FNW-B/FNW-D/FNW-E. The filtration performance of the assembled capsule was determined using the procedure and HCCF described in Example 1. The throughput was 37.8 L/m² and the CCCF turbidity was 3.40 NTU.

### Example 4 (Ex 4)

A filtration capsule was assembled as described in Method D using two discs of FNW-C and two discs of FNW-E. The orientation of discs from capsule inlet to outlet was two discs of FNW-C followed by two discs of FNW-E. The filtration performance of the assembled capsule was determined using the procedure and HCCF described in Example 1. The throughput was 53.4 L/m² and the CCCF turbidity was 3.08 NTU.

### Example 5 (Ex 5)

A filtration capsule was assembled as described in Method D using two discs of FNW-C, one disc of FNW-E, and one disc of FNW-F. The orientation of discs from capsule inlet to outlet was FNW-C/FNW-C/FNW-E/FNW-F. The filtration performance of the assembled capsule was determined using the procedure and HCCF described in Example 1. The throughput was 54.4 L/m² and the CCCF turbidity was 3.58 NTU.

### Example 6 (Ex 6)

A filtration capsule was assembled as described in Method D using three discs of FNW-E, and one disc of FNW-G. The orientation of discs from capsule inlet to outlet was FNW-E/FNW-E/FNW-E/FNW-G. The filtration performance of the assembled capsule was determined using the procedure and HCCF described in Example 1. The throughput was 46.6 L/m² and the CCCF turbidity was 3.03 NTU.

### Comparative Example A (CEx A)

A filtration capsule was assembled as described in Method D using a four disc stack of FNW-A. The filtration performance of the assembled capsule was determined using the procedure and HCCF described in Example 1. The throughput was 13.4 L/m². Insufficient CCCF volume was collected for a turbidity measurement. Fouling of the membrane was observed.

### Comparative Example B (CEx B)

A filtration capsule was assembled as described in Method D using a four disc stack of FNW-B. The filtration performance of the assembled capsule was determined using the procedure and HCCF described in Example 1. The throughput was 22.2 L/m² and the CCCF turbidity was 5.76 NTU. Fouling of the membrane was observed.

### Comparative Example C (CEx C)

A filtration capsule was assembled as described in Method D using a four disc stack of FNW-F. The filtration performance of the assembled capsule was determined using the procedure and HCCF described in Example 1. The throughput was 23.1 L/m² and the CCCF turbidity was 2.79 NTU. Caking of cell culture material was observed on the top surface of the filter stack.

### Comparative Example D (CEx D)

A filtration capsule was assembled as described in Method D using a four disc stack of FNW-G. The filtration performance of the assembled capsule was determined using the procedure and HCCF described in Example 1. The throughput was 0.6 L/m². Insufficient CCCF volume was collected for a turbidity measurement. Caking of cell culture material was observed on the top surface of the filter stack.

The filtration results for Examples 1-6 (Ex 1-Ex 6) and Comparative Examples A-D (CEx A-CEx D) are summarized in TABLE 5. The filtration capsules of Ex 1-Ex 6 had low CCCF turbidity with significantly greater throughput than filtration capsules of the Comparative Examples. In addition, the filtration capsules of the Comparative Examples had either caking of cell culture material on the top surface of the filter stack or fouling of the membrane section downstream from filter stack.

TABLE 5
Clarification of HCCF

| | Inlet to Outlet | | | |
|---|---|---|---|---|
| | Orientation of FNW | | CCCF | |
| | Discs in Filtration | Throughput | Turbidity | |
| | Capsule | (L/m²) | (NTU) | Comment |
| Ex 1 | FNW-B/FNW- | 44.4 | 3.15 | low turbidity, |
| | B/FNW-F/FNW-F | | | good throughput |
| Ex 2 | FNW-B/FNW- | 30.3 | 2.98 | low turbidity, |
| | B/FNW-G/FNW-G | | | good throughput |
| Ex 3 | FNW-B/FNW- | 37.8 | 3.40 | low turbidity, |
| | B/FNW-D/FNW-E | | | good throughput |
| Ex 4 | FNW-C/FNW- | 53.4 | 3.08 | low turbidity, |
| | C/FNW-E/FNW-E | | | good throughput |
| Ex 5 | FNW-C/FNW- | 54.4 | 3.58 | low turbidity, |
| | C/FNW-E/FNW-F | | | good throughput |
| Ex 6 | FNW-E/FNW-E/FNW- | 46.6 | 3.03 | low turbidity, |
| | E/FNW-G | | | good throughput |
| CEx A | FNW-A/FNW- | 13.4 | NM | too much membrane |
| | A/FNW-A/FNW-A | | | fouling observed - |
| | | | | low throughput |
| CEx B | FNW-B/FNW- | 22.2 | 5.76 | too much membrane |
| | B/FNW-B/FNW-B | | | fouling observed - |
| | | | | low throughput |
| CEx C | FNW-F/FNW-F/FNW- | 23.1 | 2.79 | functionalized |
| | F/FNW-F | | | nonwoven |
| | | | | caking observed - |
| | | | | low throughput |
| CEx D | FNW-G/FNW- | 0.6 | NM | functionalized |
| | G/FNW-G/FNW-G | | | nonwoven |
| | | | | caking observed - |
| | | | | low throughput |

NM = Not measured (insufficient CCCF volume was collected for a turbidity measurement)

### Example 7 (Ex 7)

A filtration capsule was assembled as described in Method D using two discs of FNW-B, one disc of FNW-D, and one disc of FNW-E. The orientation of discs from capsule inlet to outlet was FNW-B/FNW-B/FNW-D/FNW-E. A Chinese Hamster Ovary (CHO) cell culture fluid was prepared to evaluate the filtration performance of the assembled capsule. The harvested cell culture fluid (HCCF) had a packed cell volume percentage (% PCV) of 8.0%, viability of 80.0%, and turbidity of 2483 NTU. The capsule was tested according to Method D described above at a flow rate of 200 liters per square meter per hour (LMH). The resulting clarified cell culture fluid (CCCF) was collected until the differential pressure cross capsule reached 5 psi. The throughput was 59.4 L/m² and the CCCF turbidity was 4.81 NTU.

### Example 8 (Ex 8)

A filtration capsule was assembled as described in Method D using two discs of FNW-C, one disc of FNW-E, and one disc of FNW-F. The orientation of discs from capsule inlet to outlet was FNW-C/FNW-C/FNW-E/FNW-F. The filtration performance of the assembled capsule was determined using the procedure and HCCF described in Example 7. The throughput was 61.6 L/m² and the CCCF turbidity was 4.98 NTU.

### Comparative Example E (CEx E)

A filtration capsule was assembled as described in Method D using a four disc stack of FNW-A. The filtration performance of the assembled capsule was determined using the procedure and HCCF described in Example 7. The throughput was 15.3 L/m². Insufficient CCCF volume was collected for a turbidity measurement. Fouling of the membrane was observed.

### Comparative Example F (CEx F)

A filtration capsule was assembled as described in Method D using a four disc stack of FNW-F. The filtration performance of the assembled capsule was determined using the procedure and HCCF described in Example 7. The throughput was 15.3 L/m². Insufficient CCCF volume was collected for a turbidity measurement. Caking of cell culture material was observed on the top surface of the filter stack.

### Comparative Example G (CEx G)

A filtration capsule was assembled as described in Method D using a four disc stack of FNW-G. The filtration performance of the assembled capsule was determined using the procedure and HCCF described in Example 7. The throughput was 0 L/m². Caking of cell culture material was observed on the top surface of the filter stack.

The filtration results for Examples 7-8 (Ex 7-Ex 8) and Comparative Examples E-G (CEx E-CEx G) are summarized in TABLE 6. The filtration capsules of Ex 7-Ex 8 had low CCCF turbidity with significantly greater throughput than filtration capsules of the Comparative Examples. In addition, the filtration capsules of the Comparative Examples had either caking of cell culture material on the top surface of the filter stack or fouling of the membrane section downstream from filter stack.

TABLE 6
Clarification of HCCF

| | Inlet to Outlet | | | |
|---|---|---|---|---|
| | Orientation of FNW | | CCCF | |
| | Discs in Filtration | Throughput | Turbidity | |
| | Capsule | (L/m²) | (NTU) | Comment |
| Ex 7 | FNW-B/FNW-B/FNW-D/FNW-E | 59.4 | 4.81 | low turbidity, |
| | | | | good throughput |
| Ex 8 | FNW-C/FNW-C/FNW-E/FNW-F | 61.6 | 4.98 | low turbidity, |
| | | | | good throughput |
| CEx E | FNW-A/FNW-A/FNW-A/FNW-A | 15.3 | NM | too much |
| | | | | membrane |
| | | | | fouling observed - |
| | | | | low throughput |
| CEx F | FNW-F/FNW-F/FNW-F/FNW-F | 15.3 | NM | functionalized |
| | | | | nonwoven caking |
| | | | | observed - low |
| | | | | throughput |
| CEx G | FNW-G/FNW-G/FNW-G/FNW-G | 0 | NM | functionalized |
| | | | | nonwoven caking |
| | | | | observed - no |
| | | | | throughput |

NM = Not measured (insufficient CCCF volume was collected for a turbidity measurement)

### Example 9 (Ex 9)

A plastic filtration capsule was used. The capsule consisted of a sealed, circular housing. The capsule housing was prepared from two halves (upper and lower halves) which were mated and sealed together at the perimeter after the filtration elements were inserted in the internal cavity of the lower housing. Fluid inlet and vent ports were located on the upper portion of the housing and a fluid outlet port was located on the lower portion of the housing. The outlet port was centered in the middle of the lower housing surface.

Two discs (27 mm diameter) of TYPAR 3161L polypropylene spunbond nonwoven (10 mil thick, obtained from Fiberweb, Inc., Old Hickory, TN) were placed in the bottom of the lower housing. A single disc (27 mm diameter) of a MICRO-PES Flat Type 2F polyethersulfone membrane with a 0.2 micrometer nominal pore size (obtained from the 3M Company) was placed on top of the nonwoven layer. The nonwoven and membrane layers were ultrasonically welded at the margins to the bottom inner surface of the lower housing. A stack of four functionalized nonwoven layers (27 mm diameter) was then placed on top of the membrane. The stack included one disc of Functionalized Nonwoven C, two discs of Functionalized nonwoven E, and two discs of Functionalized Nonwoven G. The orientation of discs from capsule inlet to outlet was FNW-C/FNW-E/FNW-E/FNW-G/FNW-G. A polypropylene spacer ring (25.4 mm OD, 21.84 mm ID, 50 mil thick) was inserted between the third and fourth nonwoven layers (i.e., between the FNW-E and FNW-G discs. The upper and lower housings were mated together and ultrasonically welded using a Branson 20 kHz Ultrasonic welder (Model 2000xdt, Emerson Electric Company, St. Louis, MO) to form a finished filter capsule.

The overall outer diameter of the finished capsule was about 4.3 cm and the overall height including inlet, outlet, and vent ports was about 5.9 cm. The effective filtration area of the capsule was 3.2 cm² and the bed volume of the nonwoven media was 2.1 mL.

### Example 10 (Ex 10)

A finished capsule prepared according to Example 9 was attached through the inlet port of the capsule to a PendoTech Normal Flow Filter Screening System (PendoTech Company, Princeton, NJ). The capsule was flushed with Tris acetate buffer (50 mM, pH 7.5, conductivity 4 mS/cm) up to a throughput of 54 L/m² at a constant flux of 200 LMH and then flushed with air (up to a differential pressure of 5 psid) to dry the media discs. Next, the AAV2 containing cell lysate feed solution prepared in Method E was pumped through the capsule at a constant flux of 140 LMH up to a differential pressure of 15 psid. The filtrate was collected and analyzed for throughput, AAV2 capsid content, total DNA content, and turbidity. A total of two capsules were tested. The average throughput was 249 L/m² (standard deviation=69). The results for AAV2 capsid content, total DNA content are provided in TABLES 7-9.

TABLE 7
Total AAV2 Capsid Content in the Feed Solution Before
Filtration and in the Filtrate after Filtration
through a Functionalized Membrane Capsule of Ex 9

| | Capsule 1 | Capsule 2 |
|---|---|---|
| | AAV2 | AAV2 |
| | Content | Content |
| | (capsids/mL) | (capsids/mL) |
| Feed | 8.5 × 10¹¹ | 8.5 × 10¹¹ |
| Solution | | |
| Filtrate | 7.8 × 10¹¹ | 1.2 × 10¹² |

TABLE 8
Total DNA Content in the Feed Solution Before Filtration
and in the Filtrate after Filtration through a
Functionalized Membrane Capsule of Ex 9

| | Capsule 1 | Capsule 2 |
|---|---|---|
| | Total DNA Content | Total DNA Content |
| | (nanograms/mL) | (nanograms/mL) |
| Feed Solution | 4230 | 4230 |
| Filtrate | 6.6 | 14.3 |

TABLE 9
Turbidity values of the Feed Solution Before Filtration
and the Filtrate after Filtration through a Functionalized
Membrane Capsule of Ex 9

| | Capsule 1 | Capsule 2 |
|---|---|---|
| | Turbidity (NTU) | Turbidity (NTU) |
| Feed Solution | 165 | 165 |
| Filtrate | 22 | 24 |

1. A charged depth filter for removing cells and/or cellular debris from a biopharma feedstock comprising:
a first functionalized nonwoven layer having a first calculated pore size and a first dynamic charge capacity;
a second functionalized nonwoven layer having a second calculated pore size and a second dynamic charge capacity positioned after the first functionalized nonwoven layer in the direction of the biopharma feedstock flow; and
wherein the first calculated pore size is greater than the second calculated pore size, and the first dynamic charge capacity is less than the second dynamic charge capacity.

2. The charged depth filter of claim 1 wherein for the first functionalized nonwoven layer the first calculated pore size is from 40.8 μm to 65.0 μm and the first dynamic charge capacity is from 150 MY DCC mg/g to 300 MY DCC mg/g, and wherein for the second functionalized nonwoven layer the second calculated pore size is from 5.0 μm to less than 40.8 μm and the second dynamic charge capacity is from greater than 300 MY DCC mg/g to 650 MY DCC mg/g.

3. The charged depth filter of claim 1 wherein for the first functionalized nonwoven layer the first calculated pore size is from 55.0 μm to 65.0 μm and the first dynamic charge capacity is from 150 MY DCC mg/g to 300 MY DCC mg/g, and for the second functionalized nonwoven layer the second calculated pore size is from 5.0 μm to less than 55.0 μm and the second dynamic charge capacity is from 300 MY DCC mg/g to 650 MY DCC mg/g.

4. The charged depth filter of claim 1 wherein the first functionalized nonwoven layer and the second functionalized nonwoven layer are grafted with copolymers comprising interpolymerized monomer units of a quaternary ammonium containing monomer, an amide containing monomer, and an epoxy containing monomer.

5. The charged depth filter of claim 4 wherein the first functionalized nonwoven layer and the second functional nonwoven layer are grafted with copolymers comprising interpolymerized monomer units of 3-methacrylamidopropyltrimethylammonium chloride, N-vinyl pyrrolidone, and glycidyl methacrylate.

6. A charged depth filter for removing cells and/or cellular debris from a biopharma feedstock comprising:
a first functionalized nonwoven layer having a first calculated pore size and a first dynamic charge capacity;
a second functionalized nonwoven layer having a second calculated pore size and a second dynamic charge capacity positioned after the first functionalized nonwoven layer in the direction of the biopharma feedstock flow;
a third functionalized nonwoven layer having a third calculated pore size and a third dynamic charge capacity positioned after the second functionalized nonwoven layer in the direction of the biopharma feedstock flow; and
wherein the first calculated pore size is greater than the second calculated pore size and the second calculated pore size is greater than the third calculated pore size; and the first dynamic charge capacity is less than the second dynamic charge capacity and the second dynamic charge capacity is less than the third dynamic charge capacity.

7. The charged depth filter of claim 6 wherein for the first functionalized nonwoven layer the first calculated pore size is from 40.8 μm to 65.0 μm and the first dynamic charge capacity is from 150 MY DCC mg/g to 300 MY DCC mg/g, and for the second functionalized nonwoven layer the second calculated pore size is from 20.6 μm to less than 40.8 μm and the second dynamic charge capacity is from greater than 300 MY DCC mg/g to 475 MY DCC mg/g, and for the third functionalized nonwoven layer the third calculated pore size is from 5.0 μm to less than 20.6 μm and the third dynamic charge capacity is from greater than 300 MY DCC mg/g to MY DCC 650 mg/g.

8. The charged depth filter of claim 6 wherein for the first functionalized nonwoven layer the first calculated pore size is from 55.0 μm to 65.0 μm and the first dynamic charge capacity is from 150 MY DCC mg/g to 300 MY DCC mg/g, and for the second functionalized nonwoven layer the second calculated pore size is from 20.6 μm to less than 55.0 μm and the second dynamic charge capacity is from 200 MY DCC mg/g to 475 MY DCC mg/g, and for the third functionalized nonwoven layer the third calculated pore size is from 5.0 μm to less than 20.6 μm and the third dynamic charge capacity is from greater than 300 MY DCC mg/g to 650 MY DCC mg/g.

9. The charged depth filter of claim 6 wherein the third functionalized nonwoven layer is water permeable.

10. The charged depth filter of claim 6 wherein on a plot of dynamic charge capacity versus calculated pore size a water permeability line extends through a point 1 having a calculated pore size of 5.0 μm and a dynamic charge capacity of 300 MY DCC mg/g through a point 2 having a calculated pore size of 20.6 μm and a dynamic charge capacity of 525 MY DCC mg/g and the third functionalized nonwoven layer has a point 3 on the plot for the third dynamic charge capacity and the third calculated pore size that places the point 3 beneath the water permeability line.

11. The charged depth filter of claim 6 wherein the first functionalized nonwoven layer, the second functionalized nonwoven layer, and the third functionalized nonwoven layer are grafted with copolymers comprising interpolymerized monomer units of a quaternary ammonium containing monomer, an amide containing monomer, and an epoxy containing monomer.

12. The charged depth filter of claim 11 wherein the first functionalized nonwoven layer, the second functionalized nonwoven layer, and the third functionalized nonwoven layer are grafted with copolymers comprising interpolymerized monomer units of 3-methacrylamidopropyltrimethylammonium chloride, N-vinyl pyrrolidone, and glycidyl methacrylate.

13. The charged depth filter of claim 6 wherein a repeated first layer is positioned between the first layer and the second layer.

14. The charged depth filter of claim 6 wherein a membrane layer is positioned after the third functionalized nonwoven layer.

15. The charged depth filter of claim 14 wherein a nonfunctionalized nonwoven layer is positioned after the membrane layer.

16. A method of clarifying a biopharma feed stock comprising whole cells and cellular debris in a single stage comprising feeding the biopharma feed stock having a packed cell volume PCV between 2% to 12% through the charged depth filter of claim 1 to form a clarified biopharma feed stock.

17. The method of claim 16 wherein the clarified biopharma feedstock has a turbidity of less than 50 NTU.

18. The method of claim 16 wherein a throughput of the biopharma feed stock through the charged depth filter is between 30-200 L/m².

19. The method of claim 16 wherein the biopharma feed stock has a turbidity from 1,000 to 10,000 NTU.

20. The method of claim 16 wherein the flow rate is from 50-600 LMH.

21. The method of claim 16 wherein the clarified biopharma feedstock has a turbidity of less than 50 NTU and wherein the biopharma feed stock has a turbidity from 1,000 to 10,000 NTU.

22. The method of claim 21 wherein the flow rate is from 50-600 LMH.

23. The method of claim 16 wherein the cells comprise mammalian cells.

24. The method of claim 23 wherein the mammalian cells are selected from the group consisting of Chinese hamster ovary (CHO) cells, Human embryonic kidney 293 (HEK-293) cells, baby hamster kidney (BHK21) cells, NSO murine myeloma cells, or PER. C6® human cells.
